(19) United States
(12) Patent Application Publication
(10) Pub. No.: US 2025/0091320 A1
(43) Pub. Date: Mar. 20, 2025

(54) ARTICLES COMPRISING ADHESIVE AND FILM SUITABLE FOR DISASSEMBLY AND METHODS

(71) Applicant: 3M INNOVATIVE PROPERTIES COMPANY, St. Paul, MN (US)

(72) Inventors: Matthew H. Frey, Cottage Grove, MN (US); Jacob P. Podkaminer, St. Paul, MN (US); Ashley J. Smith, Woodbury, MN (US); Stephen A. Johnson, Woodbury, MN (US); Christoph Kuesters, Korschenbroich (DE); Zhou Jin, Shanghai (CN); Yunshu Zhang, Shanghai (CN); Matthew T. Johnson, Woodbury, MN (US); Luis E. Sotelo Martin, Minneapolis, MN (US); William T. Fay, Woodbury, MN (US); Jason C. Anderson, Mahtomedi, MN (US); Joseph J. Benson, Blaine, MN (US)

(21) Appl. No.: 18/966,985

(22) Filed: Dec. 3, 2024

Related U.S. Application Data
(63) Continuation-in-part of application No. PCT/IB2024/055019, filed on May 23, 2024.
Application No. PCT/IB2024/055019 is a continuation-in-part of application No. PCT/CN2023/097955, filed on Jun. 2, 2023.
(60) Provisional application No. 63/557,859, filed on Feb. 26, 2024.

(51) Int. Cl. B32B 7/12; B32B 15/01; B32B 43/00

(52) U.S. Cl. CPC B32B 7/12; B32B 15/01; B32B 43/006; B32B 2457/10

(57) ABSTRACT

Articles are described comprising a first substrate and a second substrate. At least one adhesive layer is disposed between the first and second substrates. The article further comprises a multilayer film within at least a portion of the adhesive layer(s). Also described is a method of disassembly comprising providing an adhesively bonded article as described herein; and separating the first substrate from the second substrate by delaminating the (e.g. multilayer) film. In other embodiments, adhesive articles (e.g. tape) are described comprising a (e.g. multilayer) film and methods of making adhesively bonded articles that comprise a (e.g. multilayer) film. Also described are methods of reworking, repairing, repurposing, or recycling an article, and articles.

### SUMMARY OF THE INVENTION

Adhesives are commonly used to bond parts of assembled articles in various industries such as automobiles and electronics. Due to the high cost of many of these articles, it is sometimes desirable, to modify the article such as reposition the bonded part during manufacturing, remove the bonded part for repair of the article, or disassemble the bonded parts for recycling. Mechanical disassembly of adhesively bonded substrates by existing methods can result in damage to the substrates, sometimes rendering the article inoperable. Thus, industry would find advantage in articles and methods that are amenable to disassembly.

In one embodiment, an article is described comprising a first substrate and a second substrate. At least one adhesive layer is disposed between the first and second substrates. The article further comprises a (e.g. multilayer) film within at least a portion of the adhesive layer(s). In some embodiments, (e.g. multilayer) film has an interlayer peel delamination strength at 23° C. of at least 10, 50, 100, 200, or 500 g/inch (2.54 cm).

In another embodiment, an article is described comprising a first substrate and a second substrate. At least one adhesive layer is disposed between the first and second substrates. The article further comprises a film within at least a portion of the adhesive layer(s). The bond strength between the adhesive layers and the film is greater than the interfacial strength of the film and the bond strength between the adhesive layer and substrates is also greater than the interfacial strength of the film.

In another embodiment, a method of disassembly is described comprising providing an article as described herein; and separating the first substrate from the second substrate by delaminating the (e.g. multilayer) film. In some embodiments, the (e.g. multilayer) film is delaminated by cleaving the multilayer film. The (e.g. cleavage) force for delaminating the (e.g. multilayer) film of the article can be greater than the interlayer peel delamination strength of the (e.g. multilayer) film due to the selection of adhesive(s).

In another embodiment, an adhesive article is described comprising a (e.g. multilayer) film with a first major surface and an opposing major surface. A first adhesive layer is disposed on the first major surface of the multilayer film; and optionally a second adhesive layer disposed on the second major surface of the multilayer film.

In another embodiment, a method of making an article is described comprising bonding a first substrate to a second substrate with at least one adhesive layer; wherein at least one (e.g. multilayer) film is within at least a portion of an adhesive layer. The adhesive layer(s) and multilayer film may sequentially be applied to the first and/or second substrates. In some embodiments, at least one adhesive layer together with the (e.g. multilayer) film are provided as an adhesive article (e.g. tape). The same general steps for making a new article can be performed in methods of reworking a defective article, methods of repairing an article, methods of repurposing an article, and methods of recycling an article.

In some embodiments, the article is subject to temperatures of at least 60 or 70° C. during normal use of the article. In some embodiments, the first and optionally second substrate comprises metal in contact with the adhesive layer. In some embodiments, the article is a battery. The multilayer film typically has a Tg of at least 60, 70, 80, 90, 100, 115, 120, or 125° C.

The (e.g. multilayer) film may fully span or partially span the adhesive layer. The (e.g. multilayer) film may be present at one or more edge regions of the adhesive layer(s). When the (e.g. multilayer) film partially spans the adhesive layer, the adhesively bonded article and adhesive article (e.g. tape) may further comprise an (e.g. monolithic or multilayer) electrically insulating layer that spans the adhesive layer.

In some embodiments, the adhesive layer is set back with respect to the edge of the first and second substrates. The (e.g. multilayer) film may be disposed between a first adhesive layer bonding the first substrate to the (e.g. multilayer) film and a second adhesive layer bonding the second substrate to the multilayer film. The first adhesive layer comprises the same or different adhesive composition than the second adhesive layer. In some embodiments, the first and optionally second adhesive layer have specified physical properties, e.g., Young's modulus, overlap shear strength, as described herein.

In some embodiments, the adhesive layer(s) (e.g. of the method or adhesive article) comprise a curable adhesive comprising (meth)acrylate moieties, urethane moieties, epoxy moieties, or combinations thereof.

In another embodiment, an article is described comprising a substrate, and adhesive layer disposed on the substrate, and a delaminated (e.g. multilayer) film bonded to the adhesive layer.

Also described are methods of making, reworking, repairing, repurposing, or recycling an article comprising disassembling an article by delamination of a (e.g. multilayer) film as previously described. In one embodiment, the method comprises providing a portion of a first article comprising a first substrate, an (e.g. first) adhesive layer disposed on the substrate, and a delaminated (e.g multilayer) film bonded to the adhesive layer. The method further comprises applying an (e.g. second) adhesive to the delaminated (e.g. multilayer) film (e.g. adhesively bonded to the first substrate), a second substrate or a combination thereof; and bonding the first substrate to the second substrate with the second adhesive forming a second article. In some embodiments, the method further comprises applying a monolithic film or multilayer film to at least a portion of an adhesive layer.

In some embodiments, the method of disassembly and/or reassembly is repeated at least 2, 3, or 4 times. In one embodiment, the same film may be delaminated and adhesively bonded at least 2, 3, or 4 times. In another embodiment two or more films are each delaminated and adhesively bonded at least once.

### DESCRIPTION OF DRAWINGS

FIG. 1A is a cross-sectional view of an article comprising a multilayer film spanning the adhesive layer;

FIG. 1B is a cross-sectional view of another article comprising a multilayer film partially spanning the adhesive layer;

FIG. 2 is a cross-sectional view of disassembly of an article by cleavage of a multilayer film;

FIG. 3 is a cross-sectional view of a multilayer film fully spanning the adhesive layer of an article;

FIG. 4 is a cross-sectional view of a multilayer film partially spanning (e.g., edge-localized) the adhesive layer of an article;

FIG. 5 is a cross-sectional view of an article comprising a multilayer film fully spanning the adhesive layer that is set back with respect to the substrates;

FIG. 6 is a cross-sectional view of an article comprising a multilayer film partially spanning (e.g., edge-localized) in the adhesive layer that is set back with respect to the substrates;

FIG. 7 depicts a substrate utilized for preparing test samples for cleavage tests;

FIG. 8 is a cross-sectional view of an article comprising a multilayer film fully spanning the adhesive layer for overlap shear tests;

FIG. 9 is a cross-sectional view of an electrochemical cell bonded to a first and second substrate with an adhesive layer that comprises a fully spanning multilayer film;

FIG. 10 is a cross-sectional view of a two-layer multilayer film;

FIG. 11 is a cross-sectional view of a four-layer multilayer film;

FIG. 12A is a schematic top or front plan view of a multilayer film that comprises recessed tabs corresponding to the location of cleavage between layers;

FIG. 12B is a schematic cross-sectional view along line 12B-12B;

FIG. 13 is a cross-section of an article (e.g. tape) comprising a multilayer film and an adhesive layer;

FIG. 14 is a cross section of an article (e.g. tape) comprising an adhesive layer on both major surfaces of the multilayer film;

FIG. 15 is a cross-section of an article (e.g. tape) comprising an adhesive layer partially spanning the adhesive layer and an insulating layer;

FIG. 16 is a cross sectional view of electrochemical cells bonded to each other and to a cooling plate with an adhesive layer comprising a multilayer film;

FIG. 17 is a cross sectional view of an article comprising a (e.g. multilayer) film fully spanning the adhesive layer for overlap shear strength Test Method 2;

FIG. 18 is a cross sectional view of an article comprising a (e.g. multilayer) film fully spanning the adhesive layer for overlap shear strength Test Method 3;

FIG. 19 is a cross sectional view of an article comprising a cleaved (e.g. multilayer) film and a second (e.g. multilayer) film spanning the adhesive layers for overlap shear strength Test Method 4;

FIG. 20 is a cross sectional view of an article comprising two (e.g. multilayer) films spanning the adhesive layers for cleavage strength Test Method 5;

FIG. 21 depicts a method of repair of an article.

### WRITTEN DESCRIPTION

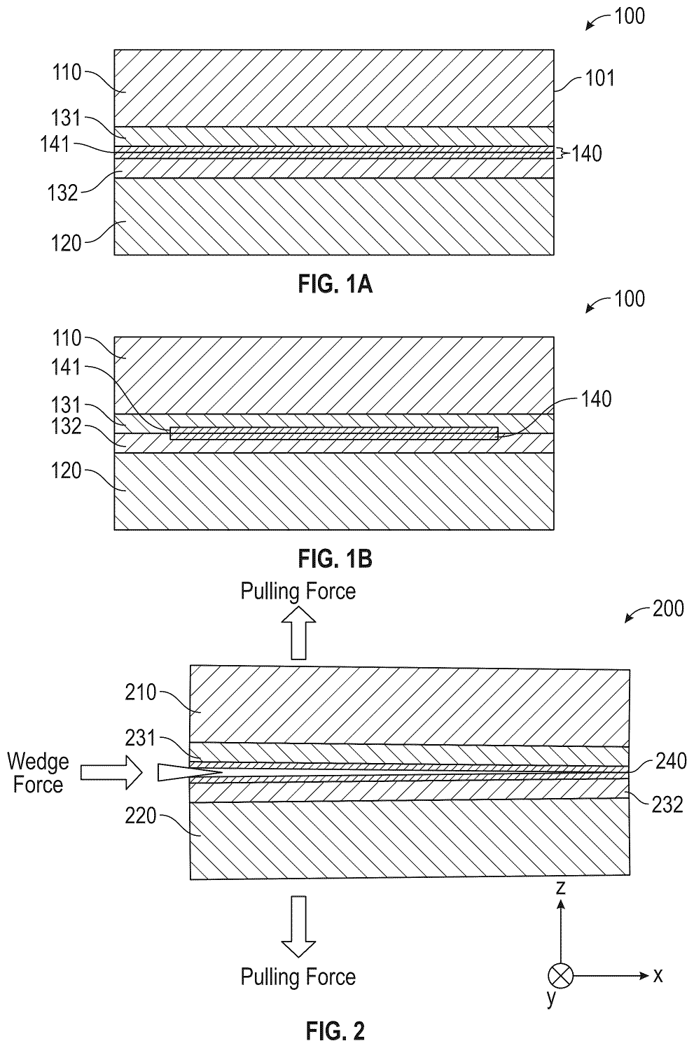

FIG. 1A is a cross-sectional view of an embodied article 100 comprising a first substrate 110 bonded to a second substrate 120 with an adhesive layer 131 and 132. A multilayer film 140, that comprises at least two different layers, is within the adhesive layer 131 and 132. The multilayer film may fully or partially span the adhesive layer. When the multilayer film fully spans the adhesive layer, such as depicted in FIG. 1, the multilayer film separates the adhesive layer into a first adhesive layer 131 and and second adhesive layer 132. Thus, the multilayer film 140 is disposed between a first adhesive layer 131 bonding the first substrate 110 to the multilayer film 140 and a second adhesive layer 132 bonding the second substrate 120 to the multilayer film 140. The first adhesive layer 131 comprises the same or different adhesive composition than the second adhesive layer 132. The edges 141 of the multilayer film may be exposed at both opposing edges (i.e. the outside limit of an object, area, or surface) of the article as depicted in FIG. 1. When the multilayer film fully spans the adhesive layer, the multilayer film extends from edge to edge of the adhesive layer in the x-direction and y-direction. Thus, the multilayer is present at the entire perimeter of an adhesive layer of the article.

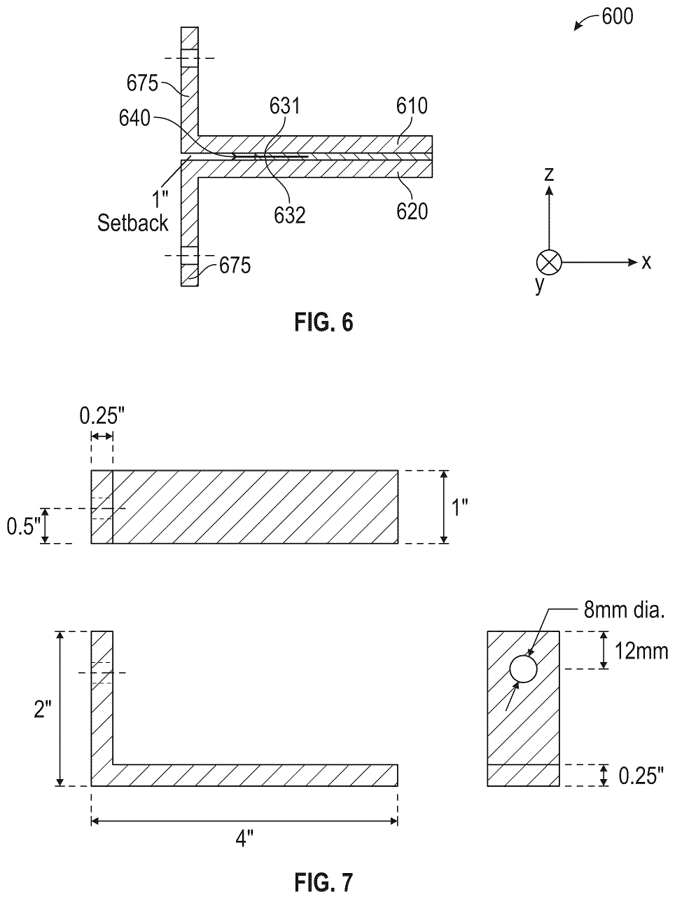

In other embodiments, the multilayer film partially spans the adhesive layer. In this embodiment, the multilayer film may be present at one edge of the adhesive layer in the x-direction and/or y-direction, such as depicted in FIGS. 4 and 6. In other embodiments, the multilayer film 140 partially spans the adhesive layer 131 and 132 when the multilayer film is fully embedded in the adhesive layer as shown in FIG. 1B. In this embodiment, all edges 141 of the multilayer film are surrounded by adhesive when the multilayer film is fully embedded.

FIG. 2 depicts a cross-sectional view of disassembly of an embodied article 200 comprising a first substrate 210 bonded to a second substrate 220 with an adhesive layer 231 and 232, and a multilayer film 240 fully spanning adhesive layers 231 and 232. The substrates 210 and 220, multilayer film 240, and adhesive layer(s) 231 and 232 may have a length in the x-direction (i.e. the longest dimension), a width in the y-direction, and a thickness in the z-direction. When opposing pulling forces are applied in a direction substantially parallel to the z-direction of the multilayer film 240, the multilayer film delaminates at an interface between layers of the multilayer film. Thus, the adhesive layer does not separate from the film, does not separate from a substrate, and does not separate cohesively. In some embodiments, the delamination may be initiated with a tool that applies a wedge force in a direction substantially parallel to the x-direction (depicted) or y-direction (not depicted) of the multilayer film. In typical embodiments, the delamination of the multilayer film is conducted at room temperature (23° C.), although delamination can be carried out at other temperatures, for example temperature above 23° C. If higher temperatures are used, the temperature is typically less than 65, 60, 55, 50, 45, 40, 35, or 30° C.; thus, lower than the temperature that may be used for thermal debonding. Such delamination occurs when the bond strength (e.g. at 23° C.) between the adhesive layers 231 and 232 and (e.g. multilayer) film 240 is greater than the interfacial strength (e.g. at 23° C.) of the multilayer film 240. Additionally, the bond strength (e.g. at 23° C.) between the adhesive layers 231 and 232 and substrates 210 and 220 is also greater than the interfacial strength (e.g. at 23° C.) of the (e.g. multilayer) film 240. Thus, the disassembly does not require debonding of the adhesive layer such as by subjecting the adhesive layer to radiant energy (e.g. light), heat, electricity, chemical agents (e.g. solvent or by reaction), magnetic field, or acoustic energy (e.g., ultrasound). In general, the term delaminating means splitting into two layers. More specifically the film has two major surfaces and a thickness in a direction orthogonal to the major surfaces. The film delaminates between the major surfaces in a direction approximately parallel to the major surfaces of the film, rather than in a direction parallel to the thickness. “Interfacial strength” of a film refers to the strength of a film (e.g. monolithic or multilayer) between the major surfaces of a film for any (e.g. specified) load condition.

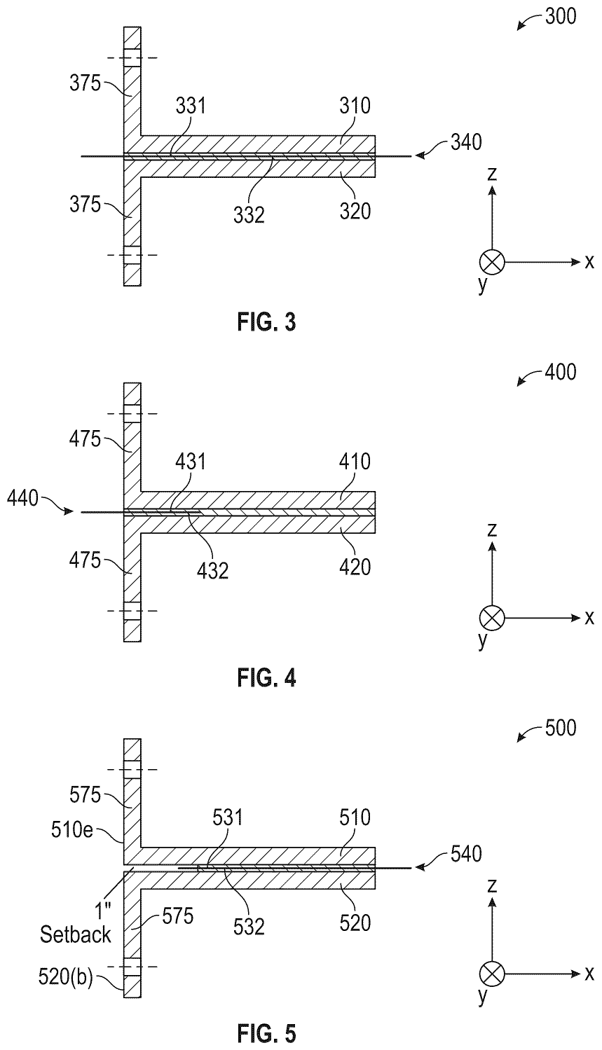

FIG. 3 is a cross-sectional view of an embodied article 300 comprising a first substrate 310 bonded to a second substrate 320 with adhesive layers 331 and 332. A multilayer film 340 is within the adhesive layers 331 and 332. The multilayer film 340 has length and width dimensions greater than or equal to the adhesive layers 331 and 332. The multilayer film 340 may also extend beyond the dimensions of the substrates 310 and 320 and the adhesive layers 331 and 332, resulting in an unbonded portion. The unbonded multilayer film portion may be characterized as a tab. The multilayer film tab may be at least partially delaminated at an interface between two different layers forming a pair of tabs. FIGS. 4-5, 8, and FIG. 12A-B also depict embodied articles comprising tabs. The article may have exposed tab(s) along one side of the bonded article, such as shown in FIGS. 3 and 4. The article may have set back tab(s) along one side of the bonded article, such as shown in FIGS. 5 and 6. Further, the article may optionally have (exposed and/or set back) tabs on opposing sides of the bonded article as shown in FIGS. 5 and 3. The tab(s) may facilitate detecting the location for delamination/cleavage during disassembly. For example, a tool for applying a wedge force may be positioned above a tab, below a tab, or between a pair of tabs. For embodiments wherein the adhesive is pressure sensitive prior to curing, a pair of tab(s) may be advantageous for disassembly prior to curing for the purpose of repositioning during manufacture of the bonded article. Notably some structural adhesives are pressure sensitive prior to curing.

The article can have various arrangements of the multilayer film within the adhesive layer. FIG. 1 depicts the multilayer film 140 fully spanning the adhesive layer. Thus, as depicted in cross-section the length of the multilayer film is at least equal to the length of the adhesive layer. Additionally, but not depicted in cross-section the width of the multilayer film is at least equal to the width of the adhesive layer. Thus, when the multilayer film is fully spanning the adhesive layer, the adhesive layer is separated into a first adhesive layer 131 and second adhesive layer 132.

In some embodiments, the first adhesive layer 131 (231, 331, 431, 531, 631, 831, 931, 1331, 1431) and second adhesive layer 132 (232, 332, 432, 532, 632, 832, 932, 1432) may comprise the same adhesive composition. In other embodiments, the first adhesive layer 131 and second adhesive layer 132 may comprise different adhesive compositions. The thickness of each adhesive layer 131 and 132 is independently typically at least 0.025, 0.05, 0.1, 0.2, 0.4, 0.6, 0.8, 1, or 2 mm. The thickness of each adhesive layer 131 and 132 is typically independently no greater than 5, 4, 3, 2, 1, or 0.5 mm. FIGS. 2, 3, 5, 8, 9, 13 and 14 also depicted the multilayer film (240, 340, 540, 840, 940, 1340, and 1440) fully spanning the adhesive layer(s).

FIGS. 4 and 6 are cross-sectional views of embodied articles 400 and 600 comprising a first substrate (410, 610) bonded to a second substrate (420, 620) with adhesive layers (431, 432, 631, 632). FIGS. 4 and 6 depict the multilayer film 440 and 640 partially spanning the adhesive layers. As depicted in cross-section, the length of the multilayer film 440 and 640 is less than the length of the adhesive layers. The width of the multilayer film may be equal to the width of the adhesive layers or less than the width of the adhesive layers. When the multilayer film 440 and 640 is partially spanning the adhesive layer, the adhesive layer is separated into a first adhesive layer 431 and 631 and second adhesive layer 432 and 632 at the location or locations the multilayer film is present within the adhesive layer. In some embodiments, the first adhesive layer and second adhesive layer may comprise the same adhesive composition. In this embodiment, the same adhesive layer 430 and 630 and same adhesive composition contacts the first substrate (410, 610) and second substrate (420, 620) at the location or locations wherein the adhesive layer lacks the multilayer film. In other embodiments, the first adhesive layer (431, 631) and second adhesive layer (432, 632) may comprise different adhesive compositions.

In some embodiments, at least about 10, 20, 30, 40, 50, 60, 70, 80, or 90% of the adhesive layer relative to an x-y plane comprises multilayer film. In some embodiments, no greater than 90, 80, 70, 60, 50, 40, 30, 20, or 10% of the adhesive layer relative to an x-y plane comprises multilayer film. In some embodiments, the multilayer film is present in the x-direction (i.e. also referred to as a penetration distance) by at least 1, 1.5, 2, 2.5, 3, 3.5, 4, 4.5, or 5 cm. In some embodiments, greater than 0.5 inches or greater than 17% of the adhesive layer relative to an x-y plane comprises multilayer film.

In FIGS. 4 and 6 the adhesive layer may be described as having a middle region disposed between two edge regions (left side and right side) and the multilayer film is present at one edge region (left side, as depicted). In another embodiment, the adhesive layer may be described as having a middle region disposed between two edge regions and the multilayer film is present at both edge regions.

FIG. 5 is a cross-sectional view of embodied article 500 comprising a first substrate 510 bonded to a second substrate 520 with adhesive layers 531 and 532. Multilayer film 540 is fully spanning the adhesive layers. In this embodiment, the multilayer film 540 and adhesive layers 531 and 532 are set back with respect to the outer edges of the substrates 510a and 510b. FIG. 6 depicts a partially spanning multilayer film 640 and adhesive layers 631 and 632 that are set back with respect to the outer edges of the substrates. In FIGS. 5 and 6, the dimension of the setback is 1 inch. In some embodiments, the adhesive layer alone or in combination with the multilayer film is set back by at least 1, 1.5, 2, 2.5, 3, 3.5, 4, 4.5, or 5 cm in the x-direction. In some embodiments, the setback is at least about 10, 15, 20, 25 or 30% relative to the x-direction dimension of the substrates. In some embodiments, the setback is no greater than 10, 15, 20, 25 or 30% relative to the x-direction dimension of the substrates. A setback of the adhesive layer alone or in combination with multilayer film can be advantageous for inserting a tool (e.g., wedge) for prying apart the substrates with a cleavage load. Notably, a setback can also provide lower cleavage strengths relative to the same article without a setback.

It is within the scope of the articles described here to include additional layers (not shown) including more than one multilayer film fully or partially spanning an adhesive layer.

In typical embodiments, the multilayer film and adhesive have high heat resistance. High heat resistance is especially important for articles that may be subject to temperatures of at least 40, 45, 50, 55, 60, 65, 70, 75, 80, 85, 90, 95, or 100° C. ranging up to, for example 200° C. during normal use of the article. For example electric vehicle (EV) batteries are designed to maintain a battery cell temperature ideally between 68-113° F. (20-45° C.). Sometimes EV batteries reach lower or higher temperatures in their normal operation, for example −10° C. to 60° C. However, EV batteries may unintentionally be exposed to greater temperatures during failure, for example during thermal runaway.

In some embodiments, the glass transition temperature, Tg, of the multilayer film (at least one layer thereof or the material thereof) is typically at least 50, 55, 60, 65, 70, 75, 80, 85, 90, 95, 100, 115, 120, or 125° C. In some embodiments, the Tg of the multilayer film (or at least one layer thereof or the material thereof) is no greater than 125, 120, 115, 100° C. For example, the multilayer film may comprise layers of polyethylene naphthalate PEN, a semi-crystalline polymer with a Tg ranging from 110-120° C. In some embodiments, the Tg the multilayer film (or at least one layer thereof or the material thereof) is no greater than 95, 90, 85, 80, 75, or 70° C. For example, the multilayer film may comprise polyethylene terephthalate and copolyesters of polyethylene terephthalate having a Tg in such a range. The melt temperature of the multilayer film (or at least one layer thereof of the material thereof) is typically at least 150, 160, 170, 180, 190, 200, 210, 220, 230, 240, 250, 260, 270, or 280° C. In some embodiments, the melt temperature of the multilayer film (or at least one layer thereof or the material thereof) is no greater than 270, 260, 250, 240, 230, 220, 210, 200, 190, 180, or 170° C. For example, multilayer films comprising polyolefins, such as (e.g. isotactic) polypropylene have a melt temperature in the range of 160-170° C. Polyolefins typically have a Tg less than 0, −10, or −20° C. The Tg and Tm can be measured with Differential Scanning calorimetry according to ASTM D3418.

The multilayer film typically comprises at least two layers comprising different thermoplastic polymers. Multilayer films typically exhibit at least two Tgs. When the multilayer film has more than two layers, and the respective layers comprise different thermoplastic polymers, there may be a distinct Tg for each different thermoplastic polymer. In some embodiments, the Tgs of the different thermoplastic polymers are similar resulting in a broader transition in calorimetry measurements that encompasses the Tgs of two or more different thermoplastic polymers of the multilayer film. In some embodiments, the Tgs of the multilayer film are at least 70, 75, 80, 85, 90, 95, 100, 115, 120, or 125° C. Thus, in some embodiments, the multilayer film lacks a Tg less than 125, 120, 115, 110, 100, 95, 90, 85, 80, 75, or 70° C.

When the adhesive is a cured adhesive such as a cured epoxy resin, the adhesive is not thermoplastic and thus typically does not exhibit a melt temperature. Rather, such cured adhesives typically decompose at high temperatures rather than exhibit such thermal transitions. Cured resins that form an insulating film are also not thermoplastic. Thus, the layers of the multilayer film that cleave during mechanical disassembly are typically not cured (e.g. resin) compositions.

In typical embodiments, the multilayer film and (e.g. cured) adhesive have high chemical resistance. In some embodiments, the bonded article comprising multilayer film, (e.g., cured) adhesive, and substrates may be exposed to chemical agents such as acidic or basic solutions, corrosive salt solutions, solvents, or oxidizing species such as peroxides. For example, structurally adhesively bonded substrates of an automotive body need to withstand salt exposure. Adhesively bonded substrates of a consumer electronic device may need to withstand exposure to cleaning agents such as detergents or light solvents applied by the user. The material compositions of the multilayer film and the adhesive layers can be selected according to chemical resistance requirements of the intended application. In another consideration of chemical resistance, for the purpose of disassembly of an adhesively bonded joint, others have applied solvents or other chemical agents to weaken the bond intentionally. This chemical method of disassembly has shortcomings of undesirably long contact or soak times, (e.g. often hours). Accordingly, the presently disclosed invention provides an advantageous alternative to chemical weakening of adhesive bonds for disassembly.

### Method of Disassembly

In one embodiment, a method of disassembly is described comprising providing an article as described herein, wherein a first substrate is bonded to a second substrate with an adhesive layer and the adhesive layer further comprises a (e.g. multilayer) film; and applying a force to separate the first substrate from the second substrate by delaminating the (e.g. multilayer) film. The presence of the (e.g. multilayer) film reduces the disassembly force, as compared to the same adhesively bonded article lacking a multilayer film at least partially spanning the adhesive layer. As demonstrated in the forthcoming examples, the presence of a (e.g. multilayer) film can reduce the cleavage strength and overlap shear strength, as compared to the same adhesively bonded substrates lacking the (e.g. multilayer) film within the adhesive layer.

The film delaminates, i.e. splits into two layers. The (e.g. multilayer) film may delaminate along a common interface. In this embodiment, each delaminated layer may have a uniform thickness (+/−10% of the average thickness). Alternatively, the film may initially delaminate along a first plane (e.g. interface) and also delaminate along other planes (e.g. interfaces) during disassembly. In this embodiment, each delaminated layer may have a uniform thickness or a thickness that varies by greater than 10%.

At least one or both substrates are preferably not damaged during the disassembly. When a substrate (e.g. battery electrochemical cell) is damaged, it cannot be reused. EV battery cells that are no longer suitable for vehicles because they can no longer store a useful proportion of their original charge, can still be used for other purposes, such as storage of energy generated by intermittent sources (e.g. from solar panels comprising photovoltaic modules). The use of EV battery cells for such other purposes is referred to herein as repurposing.

In some embodiments, a cleavage force is utilized to separate the first substrate from the second substrate. Cleavage is a load condition applicable to adhesively bonded substrates whereby a normal separation force is applied at or outside the edge of the bond area. The cleavage load condition can be generated by inserting a wedge into or near the bond edge or by engaging the substrates of a bonded article at or near the edge of the bond area, for example using a double cantilever specimen, as is known in the art. A feature of the cleavage load condition is that separation stress is concentrated at an edge of the bond area.

Although cleavage has been exemplified as a disassembly load condition, it is surmised that the multilayer film may provide reduced disassembly forces with other load conditions. For example, forces applied at angles (e.g. 5 or 10 degrees) rather than zero degrees (i.e. cleavage) would also be expected to delaminate the multilayer film. Further, other rates of separation could be suitable and controlled by use of robotic disassembly.

In some embodiments, the adhesively bonded articles can withstand a first load condition (e.g. overlap shear) that is relevant to conditions of use of the article and the multilayer film provides a means for separation (disassembly) of the first substrate from the second substrate utilizing second load conditions (e.g. cleavage) that are different than the first load condition. In other embodiments, the multilayer film provides a means for separation (disassembly) of the first substrate from the second substrate utilizing shear as a second load condition.

The average (e.g. cleavage and overlap shear) strength of a bonded article (e.g. including test samples) can vary depending on the selection of the (e.g. multilayer) film, the material(s) of the adhesive layers (e.g., their Young's modulus), the bond design (e.g., presence or not of a setback), and the mechanical behavior (e.g., stiffness) of the substrates.

In some embodiments, the average cleavage strength is less than 5000, 4000, 3000, 2000, 1500, 1000, 750, 500, or 250 N/inch. In some embodiments, the average cleavage strength is at least 10, 20, 30, 40, 50, 75, 100, or 150 N/inch. Low cleavage strength may be preferred for ease of intentional disassembly of the adhesively bonded article, as described above. In some embodiments, the average cleavage strength is at least 250, 500, 750 or 1000 N/inch. Higher cleavage strength may be suitable for robotic disassembly. The average relative cleavage strength is determined by dividing the average cleavage strength of the same adhesively bonded substrates with a multilayer film by the average cleavage strength of a control (i.e. the same adhesively bonded substrates without multilayer film) and multiplying by 100%. The average relative cleavage strength is typically less than 80, 70, 60, 50%, 40%, 30%, or 20%. In some embodiments, the average relative cleavage strength is at least 1, 2.5, 5, 10, 20, 30, 40, or 50%. In some embodiments, lower relative average cleavage strengths are desired or in other words a large reduction in average cleavage strength due to presence of the (e.g. multilayer) film. However, for robotic disassembly, higher relative average cleavage strengths may be desired, especially in combination with higher overlap shear strengths.

In some embodiments, the average overlap shear strength is at least 1, 1.5, 2, 2.5, 5, 10, 15 or 20 MPa. In some embodiments, the average overlap shear strength is no greater than 30, 25, 20, 15, 10, or 5 MPa. The overlap shear strength values reported herein were measured at ambient temperature 23° C. In typical embodiments, the overlap shear strength is between 1 and 20 MPa, between 1.5 and 15 MPa, or between 2 and 10 MPa High overlap shear strength may be preferred for the bonded article to withstand loads in normal operations. The average relative shear strength is determined by dividing the average shear strength of the same adhesively bonded substrates with a multilayer film by the average shear strength of a control (i.e. the same adhesively bonded substrates without multilayer film) and multiplying by 100%. The average relative overlap shear strength may be 100% or in other words no reduction (or increase) in the overlap shear strength when a multilayer film at least partially spans the adhesive layer. In some embodiments, the average relative overlap shear strength is less than 90%, 80%, 70%, 60%, 50%, 40%, 30%, or 20%. In some embodiments, the average relative overlap shear strength is at least 20%, 30%, 40%, 50%, 60%, 70%, 80% or 90%. Overlap shear values of 1 to 5 MPa are typically acceptable for semi-structural bonds, as may be found inside a smart phone device.

In some embodiments, the (e.g. multilayer) film may include slits or small voids to increase the (e.g. overlap shear) adhesive strength to the film, Some illustrative slit patterns are shown in U.S. Pat. No. 9,821,529; incorporated herein by reference.

Depending on the force needed to initiate cleavage, the article may be disassembled manually by hand, but more typically disassembled by use of some tool or machine that provides mechanical assist. The mechanical assist may take the form of, for example, a pulling separation force applied to the substrates or insertion and actuation (e.g., prying by rotation or bending) of a tool between the substrates. The machine may be powered by electromechanical or hydraulic means, for example. In some embodiments, the machine may be adapted for automated robotic disassembly, for example using machine vision, machine learning, grippers, and manipulators comprising actuators.

The article is generally disassembled at ambient temperature (23° C.+/−15, +/−10, or +/−5° C.). However, the disassembly can be conducted at lower or higher temperatures. Typically, the temperature is below the melt temperature of the film.

The method of disassembly provides disassembled articles including reworked articles, repaired articles, repurposed articles, and recycled articles.

In one embodiment, the article comprises a (e.g. battery module) first substrate; an adhesive layer disposed on the substrate; and a delaminated (e.g. multilayer) film bonded to the adhesive layer. The delaminated film may be a portion of the layers of the (e.g. multilayer) film, prior to disassembly.

In another embodiment, methods of making, reworking, repairing, repurposing, or recycling an article are described comprising providing a portion of a first article comprising a first substrate, an adhesive layer disposed on the substrate, and a delaminated (e.g multilayer) film bonded to the adhesive layer. The method further comprises applying an adhesive to the first substrate, a second substrate or a combination thereof; bonding the first substrate to the second substrate with the adhesive forming a second article.

In some embodiments, the method further comprises applying a monolithic film or multilayer film to at least a portion of an adhesive layer. In some embodiments, the film and at least one adhesive is applied as a tape.

In some embodiments, the method is repeated at least 2, 3, or 4 times. In some embodiments, the same (e.g. multilayer) film is delaminated and adhesively bonded at least 2, 3, or 4 times. In other embodiments, two or more films are each delaminated and adhesively bonded at least once.

In some embodiments, the delaminated film, the adhesive applied to the delaminated film, and the applied monolithic or multilayer film have a total thickness that is within 50%, 40%, 30%, 20%, or 10% of the thickness of the multilayer film of the first article.

In some embodiments, the delaminated film, the adhesive applied to the delaminated film, and the applied monolithic or multilayer film have a total thickness that is +/−0.5 mm, 0.25 mm, 0.1 mm, or 0.05 mm of the thickness of the multilayer film of the first article.

In some embodiments, the first article has a first bond thickness between the first and second substrate and the applied adhesive(s) and film(s) are selected such the bond thickness between the first and second substate of the second article is +/−10% of the first bond thickness.

Such method can provide a reworked or repaired (e.g. battery module) article comprising a first substrate; a second substrate; one or more adhesive layers disposed between the first and second substrates defining a bond thickness. The reworked or repaired (e.g. battery module) article has a bond thickness +/−10% as compared to the article prior to being reworked or repaired.

In some embodiments, the reworked or repaired (e.g. battery module) article further comprises a film within at least a portion of the adhesive layer.

The bonded article can be disassembled a first time with a first cleavage strength and disassembled a second time with a second cleavage strength. In some embodiments, the same bonded article can be dissembled a third, fourth, and fifth time with a third, fourth, and fifth cleavage strength. The second, third, fourth, fifth, etc. cleavage strengths can be described as a subsequent cleavage strengths.

The first and one or more subsequent (e.g. second, third, fourth, fifth, or combination thereof) cleavage strengths may be the same or approximately the same (e.g., within +/−10% of the average value of the first cleavage strength). In other embodiments, the first and one or more subsequent cleavage strengths may differ by less than +/−50%, +/−40%, +/−30%, or +/−20% of the average value of the first cleavage strength. In some embodiments, a decrease in cleavage strength from the first cleavage strength to a subsequent cleavage strength provides adequate strength of the reworked, repaired, or recycled article. In some embodiments, an increase in cleavage strength from the first cleavage strength to a subsequent cleavage strength is not excessive such that it would prevent subsequent rework, repair, repurposing, or recycling of the adhesively bonded article.

When the bonded article comprises different films or a multilayer film comprising layers with different delamination strengths, the bonded article may have two or more different cleavage strengths. The cleavage strengths can differ (increase or decrease) by, for example, a factor of 500, 250, 100, 50, 25, 10, 5, or 2.

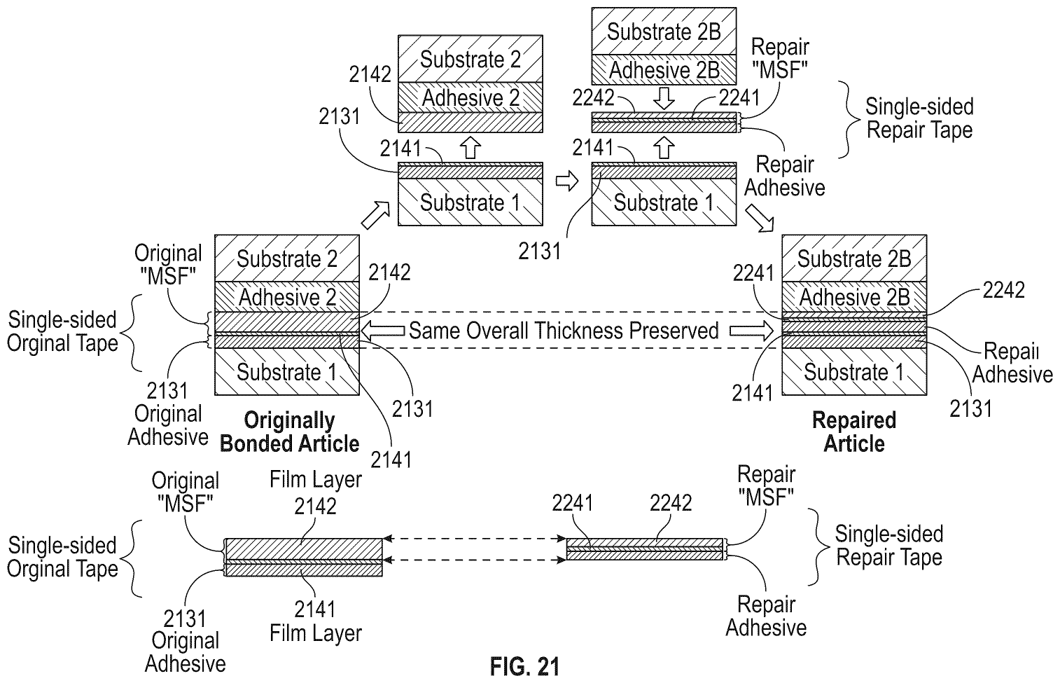

One illustrative method of repair is shown in FIG. 21 that depicts from left to right, an Originally Bonded Article being disassembled and Original Substrate 2 being replaced with Substrate 2B by use of Adhesive 2B and a Repair Tape. Substrate 2 may be, for example, a defective part. The Originally Bonded Article comprises Substrate 1 adhesively bonded with Original Adhesive 2131 to a film (Original “MSF”) and Substrate 2 adhesively bonded with Adhesive 2 to the film (Original “MSF”). In some embodiments, Substrate 2 (and Substrate 2B) is a cooling plate or lid. In some embodiments, Adhesive 2 (and Adhesive 2B) is a thermally conductive adhesive. In some embodiments, Substrate 1 is a battery cell.

Original Adhesive 2131 of the Originally Bonded Article has a bond strength with Substrate 1 and a bond strength with the film (Original “MSF”). Adhesive 2 of the Originally Bonded Article has a bond strength with Substrate 2 and a bond strength with the film (Original “MSF”). Such bond strengths are greater than the interfacial strength of the film at ambient temperature. Thus, the Originally Bonded Article can be disassembled by interfacial film failure (i.e. delamination) at ambient temperature, rather than adhesive failure.

The Originally Bonded Article may be constructed with a Single-sided Original Tape that comprises Original Adhesive 2131 disposed on a multilayer film. For simplicity, the multilayer film is depicted as having two layers, a Film Layer 2141 and a Film Layer 2142.

When the film is a multilayer film, the Originally Bonded Article can be disassembled by delaminating the Film Layer 2141 from the Second Film Layer 2142. Substrate 2, remaining bonded to Film Layer 2142 with Adhesive 2, is separated from Substrate 1 that remains bonded to Film Layer 2141 with Original Adhesive 2131. Substrate 2, remaining bonded to Film Layer 2142 with Adhesive 2, is removed (e.g. discarded).

The repair involves replacing Substrate 2 with Substrate 2B. For the repair, Adhesive 2B is utilized to bond Substrate 2B to a film (Repair “MSF”) of a Repair Tape. The Repair Tape further comprises a Repair Adhesive that is contacted with and bonded to Film Layer 2141 of the Originally Bonded Article. Film Layer 2141 remains bonded to Substrate 1 with Original Adhesive 2131. The film (Repair “MSF”) can be a monolithic film or multilayer film. For simplicity, the Repair “MSF” is depicted as a multilayer film having two layers, a Film Layer 2241 and a Film Layer 2242.

Original Adhesive 2131 of the Originally Bonded Article has a bond strength with Substrate 1 and a bond strength with the film (Original “MSF”). Adhesive 2B of the Repaired Article has a bond strength with Substrate 2B and a bond strength with the film (Repair “MSF”). The Repair Adhesive has a bond strength with Film Layer 2141 and the film of the Repair “MSF”. When bond strengths are greater than the interfacial strength of the film at ambient temperature, the Repaired Article can be disassembled by film failure at ambient temperature, rather than adhesive failure.

Each of the adhesive and film layers have a specified thickness. In some embodiments, the thickness of the adhesive applied to the delaminated film and the thickness of the applied monolithic or multilayer film (e.g. of the Repair Tape) are selected such that the when combined with the thickness of the delaminated film (e.g. 1241), the total thickness is within 50%, 40%, 30%, 20%, or 10% of the thickness of the (e.g. multilayer) film (Original “MSF”) of the first article, prior to delaminating.

In some embodiments, the thickness of the adhesive applied to the delaminated film and the thickness of the applied monolithic or multilayer film (e.g. of the Repair Tape) are selected such that the when combined with the thickness of the delaminated film (e.g. 1241), the total thickness can be within 1 mm (0.5 mm, 0.25 mm, 0.1 mm, 0.05 mm) of the thickness of the original (e.g. multilayer) film (Original “MSF”) of the first article, prior to delaminating.

It is appreciated that the Originally Bonded Article can be repaired with a repair film and repair adhesive as described herein even when the Originally Bonded Article lacked a multilayer film in the first place. For example, an Originally Bonded Article lacking a multilayer film may be disassembled by debonding the adhesive with heat or electrical current. In this embodiment, the Originally Bonded Article would not include a (e.g. multilayer) film and thus, film layers would not be present after separating Substrate 1 from Substrate 2. The Repaired Article would comprise a (e.g. multilayer) film is the absence of any remaining film portion (e.g. Film Layer 1241 of a delaminated multilayer film).

### Bonded Articles

Various adhesively bonded articles can be prepared comprising a multilayer film at least partially spanning the adhesive layer that adheres at first and second substrates. In some embodiments, a common adhesive layer may bond more than two substrates. For example, a single cooling plate may be adhesively bonded to more than one electrochemical cell (each electrochemical cell may be considered a substrate).

Various organic and inorganic substrates can be used including for example polymers, metals, composites, ceramics, glass, and combinations thereof, including composite materials. The metals and metal surfaces include steels and coated steels such as stainless steels, tin-free steel, tin-plated steel, nickel plated steel, copper-clad stainless steel, and electrolytically chrome coated steel (ECCS); aluminum and aluminum alloys; copper; bronze; titanium and titanium alloys; magnesium and magnesium alloys.

In some embodiments, the substrate may be considered rigid. For example, the ¼ inch (0.635 cm) aluminum sheet used to evaluate the cleavage strength is rigid. However, the same test methods were also used to evaluate thinner substrates that are more flexible, such as a 0.9 mm aluminum sheet. A decrease in cleavage strength was obtained even though the substrate was bent after testing.

Substrates can be flat or have a curved surface. Substrates may be components that may comprise multiple materials. Exemplary substrates include electrochemical cells, structural members (e.g., housings, lids, cross-members, or other support members in, for example, an automobile or more specifically the battery pack of an EV), thermal management components (e.g., cooling plates or thermal barriers of, for example, an (EV) battery pack), electrical components (e.g., busbars, leads, circuit boards, chip carriers, power modules, display modules, motor stators, motor rotors), Preferred substrates include electrochemical cells, thermal management components, and structural members of an EV battery pack. Exemplary articles include (e.g. laminated or composite) building articles, electrical and electronic parts, motor vehicle parts, abrasive articles, and medical devices. In some embodiments, the articles can include components of computers, mobile hand-held electronic devices including phones, and touch-sensitive panels. In some embodiments, the articles can be photovoltaic modules (e.g. solar panel) comprising a semiconductor substrate, a cover glass substrate, and optionally a back substrate, along with adhesive layers and the multilayer film. Preferred articles include EV battery packs, including EV battery modules. Adhesives are used to bond substrates within EV battery packs, including the joining of electrochemical cells to structural members, electrical busbars or leads, or thermal management components. In some embodiments, the (e.g. multilayer) film that can facilitate disassembly by delaminating the (e.g. multilayer) film is utilized for battery cell can wrap, bonding and insulation between battery cells. Module side plate insulation, module housing insulation, and/or battery cell to cooling plate insulation.

Electrochemical cells have high contents of refined minerals, usually including cobalt, nickel, manganese, copper, aluminum, and lithium. Accordingly, it is desirable to extend the useful life and to facilitate recycling of EV electrochemical cells. Sometimes the adhesives used to bond electrochemical cells to structural members, electrical busbars or leads, or thermal management components in the battery module or pack present significant challenges for disassembly of the module or pack. These disassembly challenges can hamper repair, replacement, repurposing in a second use, or recycling of electrochemical cells from EV battery modules and packs. Sometimes the electrochemical cells cannot be separated from structural members, electrical busbars or leads, or thermal management components without damaging the cells. Articles of the present disclosure provide a means for disassembly of battery modules or packs, including removal of electrochemical cells without damage.

In favored embodiments, the substrates and (e.g., cured) adhesive have high heat resistance and are also chemical resistant. Due to these properties, debonding the adhesive by exposure to heat or solvents is challenging. In some embodiments, at least one or both substrates are metals or comprise a metal surface layer in contact with the adhesive layers. For example, in one representative embodiment, the first substrate may be a battery cell and the second substrate may be a cooling plate. In this embodiment, the fully spanning multilayer film may also function as an electrically insulating layer that electrically insulates the battery cell or cells from the cooling plate.

The multilayer film together with one or more adhesive layer (e.g. a tape) may be applied to a battery as a cell can wrap, on the side wall of a battery pack, to the cold plate in a battery pack, or other parts of a battery pack, where later disassembly would be desired. As an added benefit, the multilayer film may also provide necessary electrical insulation within the battery pack to prevent undesirable electrical shorts or arcing.

FIG. 9 is a cross-sectional view of an electrochemical cell (e.g. 9 volt battery) bonded to a first substrate 910 and second substrate 920 with first adhesive layer 931 and second adhesive layer 932. In this embodiment, multilayer films 940 fully span the adhesive layers. The multilayer film between the electrochemical cell and first substrate 910 may be the same or a different multilayer film than the multilayer film between the electrochemical cell and second substrate 920. One or both multilayer films may alternatively partially span the adhesive layer and/or the adhesive layer may be set back, as previously described. This adhesively bonded article can be disassembled as further described in the examples. In one embodiment, the average cleavage strength was reduced from 251 N to 36 N, by including multilayer films spanning the adhesive layers and avoided damage to the electrochemical cell.

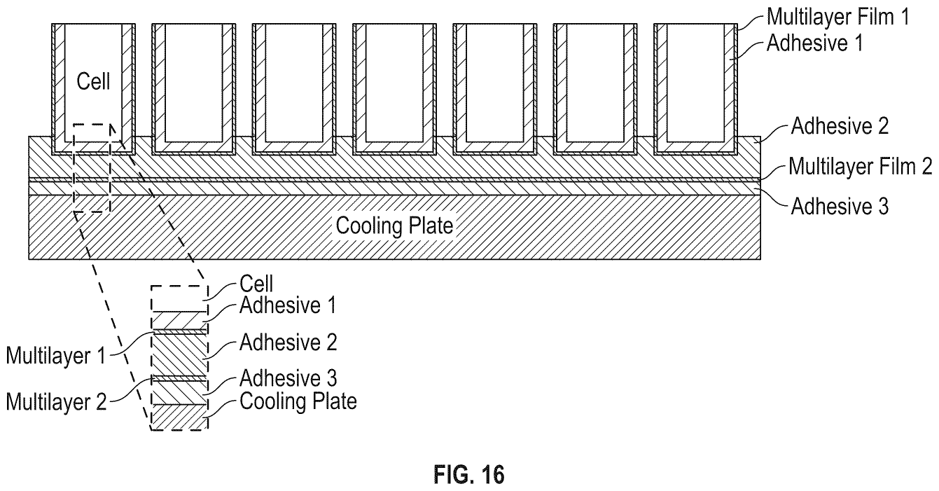

FIG. 16 is a cross-sectional view of a battery pack comprising two or more electrochemical cells optionally bonded to a cooling plate. A first multilayer film is disposed between a first adhesive layer and second adhesive layer. The first multilayer film bonded to each electrochemical cell with the first adhesive layer also surrounds the electrochemical cell to provide electrical insulation. A second multilayer film is disposed between the second adhesive layer and a third adhesive layer. The third adhesive layer is bonded to the second multilayer film and the underlying cooling plate. The adhesive layers may comprise the same or different adhesive compositions. The multilayer films may be the same or different multilayer films. The second multilayer film can be utilized to separate the battery pack from the cooling plate. The first multilayer film can be utilized to separate the electrochemical cells from each other. It is also contemplated that the first or second multilayer film may be absent or may be replaced by a monolithic film.

It is appreciated that a “battery” article may include additional components as known in the art. For example, the battery article may include components that provide physical support, thermal management, electrical interconnection, and impact protection to the battery electrochemical cells. Electric vehicle (EV) battery modules and battery packs are examples of battery articles.

### Multilayer Film

With reference to FIG. 10 a multilayer film 1000 comprises at least two layers, 1001 and 1002 with an interface between them. In some embodiment, the multilayer film comprises at least 3, 4, 5, 6, 7, 8, 9, or 10 layers. For example, FIG. 11 depicts multilayer film 1100 that comprises four layers, 1101, 1102, 1103, and 1104. In yet other embodiments, the multilayer film comprises a plurality or in other words numerous layers.

For example, the multilayer film may have at least 10, 15, 20, 50, 100, 150, 200, 250 or 300 layers. In some embodiments, the multilayer film has no greater than 1000, 900, 800, 700, 600, 500, 400, 300, 200, 100, 50, 20, 15, or 10 layers. The thickness of the layers can vary depending on the number of layers. The multilayer film may comprise one or more layers having a thickness of at least 50 nm, 75 nm, 100 nm, 250 nm, 500 nm, 1 micron, 2 microns, 3 miconrs, 4 microns, 5 microns, 10 microns, 25 microns, or 30 microns. In some embodiments, the multilayer film may comprise two or more layers having a thickness of no greater than 150, 100, 50, 25, 15, 10, or 5 microns.

The overall thickness of the total layers of the multilayer film is typically at least 5 micrometers. The overall thickness of the multilayer film is typically no greater than 500 micrometers. In some embodiments, the overall thickness of the multilayer film is at least 10, 15, 20, 25, 30, 35, 40, 45, 50, 55, 60, 65, 70, or 75 microns. In some embodiments, the overall thickness of the multilayer film is no greater than 250, 200, 175, 150, 125, 100, 75 or 50 microns. In some embodiments, the multilayer film is of a sufficient thickness to provide electrical insulation between an electrochemical cell (substrate) and another component (substrate), such as a cooling plate, for example a breakdown voltage between the substrates of greater than 1000 volts or even greater than 5000 volts.

FIG. 11 depicts a multilayer film 1100 comprising plurality of individual polymer layers that together form a stack which may form all or part of a multilayered polymer film 1100. In the depicted embodiment, the stack is composed of at least two types of polymer layers: polymer layers A (1104), polymer layers B (1103), and optionally polymer layers C (1102), which are composed of different polymer compositions. These different layer types are organized into repeating groups of layers A, B, C, A, B, C, and so forth. The front and back major surfaces of adjacent layers are in intimate contact with each other. In some embodiments, the multilayer film comprises at least four layers (e.g. A, B, C, and D (1101).

In typical embodiments the multilayer film comprises at least two directly adjacent thermoplastic polymer layers (e.g. A and B). In some embodiments, the multilayer film comprises at least two (e.g. coextruded) directly adjacent thermoplastic polymer layers. In some embodiments, the directly adjacent layers that delaminate from each other at an interface between them during disassembly are (e.g. coextruded) thermoplastic polymer layers. In some embodiments, at least 3, 4, 5, 6, 7, 8, 9, 10 or more including all the layers of the (e.g. coextruded) multilayer film comprise thermoplastic polymer layers that are melt processable at a temperature in a range of 250-300C. In some embodiments, the (e.g. coextruded) multilayer film is stretched during manufacture. In this embodiment, at least one of the thermoplastic polymer layers may be oriented and may have a birefringence of at least 0.05. The oriented thermoplastic polymer layer typically separates from an adjacent non-oriented layer upon cleavage of the multilayer film during disassembly of the adhesively bonded substrates. As used herein, “coextruded” refers to the process of extruding two or more materials through a single die with two or more orifices into the die arranged so that the extrudates merge and weld together into a laminar structure before cooling or chilling, that is, quenching. Coextrusion is often employed as an aspect of other processes, for instance, in blown film and cast film processes.

The multilayer film typically does not comprise layers of pressure sensitive adhesive. Thus, the (e.g. coextruded) thermoplastic polymer layers of the multilayer film are not pressure sensitive adhesives. In some embodiments, the thermoplastic polymer layers of the multilayer film are distinguished from a pressure sensitive adhesive in view of having poor peel adhesion to a substrate. For example, the 90 degree peel strength of the thermoplastic polymer layers to aluminum is less than 200 or 100 g/inch at 23° C. and a rate of 12 inches per minute.

In some embodiments, the thermoplastic polymer layers are distinguished from a pressure sensitive adhesive, in view of the thermoplastic polymer layers having a shear storage modulus (G′) of greater than 3×10⁶ dyne/cm² (0.3 MPa) at room temperature (25° C.) and a frequency of 1 Hz. In some embodiments, the thermoplastic polymer layers are distinguished from a pressure sensitive adhesive in view of the thermoplastic polymer layers having a glass transition temperature greater than 25° C.

The multilayer film may be prepared from various thermoplastic polymers. The thermoplastic polymers of the multilayer film may be selected based on the desired heat resistance and desired delamination strength. In typical embodiments, the multilayer film is dimensionally stable at temperatures up to 110° C. or greater, typically exhibiting no greater than 5, 4, 3, 2, 1 or 0.5% shrinkage. In other words, the multilayer film is not a shrink film. In typical embodiments, the multilayer film, adhesive, as well as other optional layers disposed between the adhesively bonded substrates lack intumescent particles. The premature expansion of intumescent particles may also result in premature disassembly of adhesively bonded substrates (e.g. battery cell and cooling plate of EV battery). Further, in some embodiments, the multilayer film, adhesive, as well as other optional layers disposed between the adhesively bonded substrates are not release layers that typically comprise fluoropolymers or other (e.g. silicon-containing and/or fluorinated) materials that exhibit a high advancing contact angle with water (e.g. at least about 90 degrees).

In some embodiments, the multilayer film comprises polyolefin polymers, i.e. a polymer produced from an alkene with the general formula CₙH₂ₙ as a monomer. Polyethylene is produced by polymerizing ethylene with or without one or more comonomers, polypropylene by polymerizing propylene with or without one or more comonomers, etc. Thus, polyolefins include interpolymers such as ethylene/a-olefin copolymers, propylene/alpha-olefin copolymers, etc. The melting point of polyolefins is typically measured by the as described in U.S. Pat. No. 5,783,638.

Some multilayer films comprising polyolefin layers are described for example in U.S. Pat. No. 9,969,907; incorporated herein by reference. The films described therein comprise layers described as “Adhesion Layers” comprising polar ethylene copolymers, such as ethylene/alpha, beta-ethylenically unsaturated carboxylic acid copolymers, ethylene vinyl acetate (“EVA”) copolymers, ethylene alkyl(meth)acrylate copolymers and blends of two or more of these. Notably such adhesion layers are typically not pressure sensitive adhesives, as previously described.

In some embodiments, the polar ethylene copolymers are blended low density polyethylene (LDPE), The amount of LDPE is typically at least 2, 3, 4, or 5 wt. % and no greater than 25, 20, 15, or 10 wt. % of the blend.

In some embodiments, the polar ethylene copolymers or blends typically have a melt index (MI as measured by the procedure of ASTM D-1238 (190C/2.16 kg) of at least about 0.3, 0.7, 1, 5, or 10 g/10 min. In some embodiments, the melt index is less than 100, 75, 50 or 30 g/10 min.

The polyolefin multilayer film typically comprises outer layer(s) comprising the polar ethylene copolymers or blend thereof that are contacted with the (e.g. metal) substrate(s).

The polyolefin multilayer films typically comprise one or more polyolefin layers typically having a higher olefin content than the polar ethylene copolymers or blends. Suitable polymers include high density polyethylene (“HDPE”, density than 0.93 g/cm³) polypropylenes (PP), medium density polyethylene (“MDPE”; density 0.920-0.930 g/cm³), and blends thereof. The propylene-based polymers include polypropylene homopolymer, copolymers of propylene and one or more other olefin monomers, a blend of two or more homopolymers or two or more copolymers, and a blend of one or more homopolymer with one or more copolymer, typically having a melting point of 125° C. or more. The polypropylene-based polymers include substantially isotactic propylene homopolymer, random propylene copolymers, and graft or block propylene copolymers.

Suitable propylene-based polymer blends comprise the propylene-based polymer in the amounts of at least 30, 35, or 40 wt. % of the blend. The amount of propylene-based polymer of the blend is typically no greater than 80, 70, or 60 wt. % of the blend.

The propylene copolymers typically comprise at least 85, 87 or 90, mole percent units derived from propylene. The propylene copolymer typically comprises at least one alpha-olefin no greater than 20, 12, or 8 caron atoms. The alpha-olefin is typically a C3-20 linear, branched or cyclic a-olefin. In some embodiments, the propylene polymer as a MFR (measured in dg/min at 230° C./2.16 kg,) of at least 0.5, 1, 1.5, 2, or 2.5 dg/min and typically no greater than 25, 20, or 15 dg/min.

The layer comprising the polar ethylene copolymers is strippable from the polypropylene layer. The interlayer peel strength is described in U.S. Pat. No. 9,969,907 as ranging from about 5 to 15 lbf/inch width. However, the cleavage strength can be significantly greater depending on the selection of the adjacent adhesive layer(s) as described herein.

In some embodiments, the multilayer polyolefin film comprises two layers, a first layer comprising polar ethylene copolymers or blend thereof and a second layer comprising a propylene based polymer. In another embodiment. In another embodiments, the multilayer polyolefin film comprises at least three layers, at least two layer of polar ethylene copolymers or blend thereof disposed on both major surfaces of a propylene based polymer layer or at least two layer of propylene based polymer layer on both major surfaces of a layer comprising polar ethylene copolymers or blend thereof. The layers with polar ethylene copolymers may exhibit better adhesion to the adhesive layer.

The multilayer films may further optionally comprise one or more layers of ethylene based polymers having a density less than about 0.92 g/cm³. These include the high pressure, free-radical low density polyethylene (LDPE), and heterogeneous linear low density polyethylene (LLDPE), ultra low density polyethylene (ULDPE), and very low density polyethylene (VLDPE), as well as multiple-reactor ethylenic polymers (“in reactor” blends of Ziegler-Natta PE and metallocene PE. When present, such layers may be present between a propylene based polymer layer and layer comprising polar ethylene copolymers or blend thereof.

When higher heat resistance is required, the multilayer film typically comprises thermoplastic polymers having higher Tgs and/or melt temperatures, as previously described. Representative thermoplastic polymers include polyester polymers including copolyesters, acrylic polymers (e.g. polymethylmethacrylate and copolymers thereof), polyurethane polymers, polyether polymers, and polyamides including silicone polyoxamides.

In some embodiments, the multilayer film comprises thermoplastic polymers including homopolymers of polymethylmethacrylate (PMMA), such as those available from Ineos Acrylics, Inc., Wilmington, DE, under the trade designations CP71 and CP80, or polyethyl methacrylate (PEMA), which has a lower glass transition temperature than PMMA. Additional thermoplastic polymers of the multilayer film include copolymers of PMMA (coPMMA), such as a coPMMA made from 75 wt % methylmethacrylate (MMA) monomers and 25 wt % ethyl acrylate (EA) monomers, (available from Ineos Acrylics, Inc., under the trade designation Perspex CP63), a coPMMA formed with MMA comonomer units and n-butyl methacrylate (nBMA) comonomer units, or a blend of PMMA and poly(vinylidene fluoride) (PVDF) such as that available from Solvay Polymers, Inc., Houston, TX under the trade designation Solef 1008.

In some embodiments, such thermoplastic polymers typically comprises aromatic or cycloaliphatic moieties.

In some embodiments, the multilayer film comprises polyester polymers (e.g. aromatic) polyesters (homopolymers and copolymers) such as poly(ethylene terephthalate, “PET”), polybutylene terephthalate, polyhexamethylene terephthalate, polybutylene naphthalate, polyhexamethylene naphthalate, poly(ethylene naphthalate, “PEN”), copolymerized blends thereof, or copolyesters thereof such as 90/10 coPEN or amorphous poly(ethylene terephthalate) copolymer (also referred to herein as PETG). The polyester polymers typically have a molecular weight of at least 10,000; 20,000; or 30,000 Daltons and typically no greater than 50,000 Daltons. In some embodiments, the layers that delaminate from each other at an interface during disassembly are (e.g. coextruded) thermoplastic polyester layers. In some embodiments, at least 3, 4, 5, 6, 7, 8, 9, 10 or more including all the layers of the (e.g. coextruded) multilayer film comprises thermoplastic polyester layers.

In some embodiments, the multilayer film may be characterized as a multilayer optical film (MOF). Multilayer optical films, i.e., films that provide desirable transmission and/or reflection properties at least partially by an arrangement of microlayers of differing refractive index, are known. Multilayer optical films can be prepared by coextrusion of alternating thermoplastic polymer layers. See, e.g., U.S. Pat. No. 3,610,729 (Rogers), 4,446,305 (Rogers et al.), 4,540,623 (Im et al.), 5,448,404 (Schrenk et al.), and 5,882,774 (Jonza et al.).

A multilayer optical film includes individual microlayers having different refractive index characteristics so that some light is reflected at interfaces between adjacent microlayers. The microlayers are sufficiently thin so that light reflected at a plurality of the interfaces undergoes constructive or destructive interference in order to give the multilayer optical film the desired reflective or transmissive properties. For multilayer optical films designed to reflect light at ultraviolet, visible, or near-infrared wavelengths, each microlayer generally has an optical thickness (a physical thickness multiplied by refractive index) of less than about 1 μm. However, in the present invention the difference in crystallinity or birefringence that contributes to the high cleavage strength is of primary interest rather than the optical properties. Thicker layers are also typically included, such as skin layers at the outer surfaces of the multilayer optical film, or protective boundary layers (PBLs) disposed within the multilayer optical films, that separate coherent groupings (referred to herein as “packets”) of microlayers.

In some embodiments, the MOF film may be characterized as a reflective polarizer, wherein at least some of the optical layers are formed using birefringent polymers, in which the polymer's index of refraction has differing values along orthogonal Cartesian axes of the polymer. Generally, birefringent polymer microlayers have their orthogonal Cartesian axes defined by the normal to the layer plane (z-axis), with the x-axis and y-axis lying within the layer plane. Birefringent polymers can also be used in non-polarizing applications.

In some cases, the microlayers have thicknesses and refractive index values corresponding to a ¼-wave stack, i.e., arranged in optical repeat units or unit cells each having two adjacent microlayers of equal optical thickness (f-ratio=50%), such optical repeat unit being effective to reflect by constructive interference light whose wavelength λ is twice the overall optical thickness of the optical repeat unit. Other layer arrangements, such as multilayer optical films having 2-microlayer optical repeat units whose f-ratio is different from 50%, or films whose optical repeat units include more than two microlayers, are also known. These optical repeat unit designs can be configured to reduce or to increase certain higher-order reflections. See, e.g., U.S. Pat. No. 5,360,659 (Arends et al.) and U.S. Pat. No. 5,103,337 (Schrenk et al.). Thickness gradients along a thickness axis of the film (e.g., the z-axis) can be used to provide a widened reflection band, such as a reflection band that extends over the entire human visible region and into the near infrared so that as the band shifts to shorter wavelengths at oblique incidence angles the microlayer stack continues to reflect over the entire visible spectrum. Thickness gradients tailored to sharpen band edges, i.e., the wavelength transition between high reflection and high transmission, are discussed in U.S. Pat. No. 6,157,490 (Wheatley et al.).

In exemplary embodiments, the microlayers are arranged into optical repeat units each of which has an optical thickness, the optical repeat units being arranged to provide a substantially monotonically or smoothly increasing optical thickness profile. At least some of the N microlayers comprise polyethylene naphthalate or a copolymer thereof, and N is 350 or less, or 300 or less, or in a range from 250 to 350, or in a range from 275 to 375. Alternatively, at least some of the N microlayers comprise polyethylene terephthalate or a copolymer thereof, and N is 800 or less, or 650 or less, or in a range from 300 to 650, or in a range from 500 to 650.

The reflective and transmissive properties of multilayer optical film are a function of the refractive indices of the respective microlayers and the thicknesses and thickness distribution of the microlayers. Each microlayer can be characterized at least in localized positions in the film by in-plane refractive indices nₓ, n_{y}, and a refractive index n_{z} associated with a thickness axis of the film. These indices represent the refractive index of the subject material for light polarized along mutually orthogonal x-, y-, and z-axes, respectively. These indices may be labeled n1x, n1y, n1z for a first layer, labeled n2x, n2y, n2z for a second layer, their respective layer-to-layer differences being Δnₓ, Δn_{y}, Δn_{z}. For ease of explanation in the present patent application, unless otherwise specified, the x-, y-, and z-axes are assumed to be local Cartesian coordinates applicable to any point of interest on a multilayer optical film, in which the microlayers extend parallel to the x-y plane, and wherein the x-axis is oriented within the plane of the film to maximize the magnitude of Δnₓ. Hence, the magnitude of Δn_{y} can be equal to or less than—but not greater than—the magnitude of Δnₓ. Furthermore, the selection of which material layer to begin with in calculating the differences Δnₓ, Δn_{y}, Δn_{z} is dictated by requiring that Δnₓ be non-negative. In other words, the refractive index differences between two layers forming an interface are Δnⱼ=n₁ⱼ−n₂ⱼ, where j=x, y, or z and where the layer designations 1,2 are chosen so that n₁ₓ≥n₂ₓ., i.e., Δnₓ≥0.

In practice, the refractive indices are controlled by judicious materials selection and processing conditions. Such multilayer films are made by co-extrusion of a large number, e.g. tens or hundreds of layers of two alternating polymers A, B, typically followed by passing the multilayer extrudate through one or more multiplication die, and then stretching or otherwise orienting the extrudate to form a final film. The resulting film is typically composed of many hundreds of individual microlayers whose thicknesses and refractive indices are tailored to provide one or more reflection bands in desired region(s) of the spectrum, such as in the visible or near infrared. To achieve high reflectivity with a reasonable number of layers, adjacent microlayers typically exhibit a difference in refractive index (Δnₓ) for light polarized along the x-axis of at least 0.05. If the high reflectivity is desired for two orthogonal polarizations, then the adjacent microlayers also can be made to exhibit a difference in refractive index (Δn_{y}) for light polarized along the y-axis of at least 0.05.

In exemplary embodiments, a reflective polarizer has a block (x) axis and a pass (y) axis, and first and second opposed major surfaces exposed to air and therefore exhibiting Brewster angle reflection minima, the major surfaces being disposed perpendicular to a z-axis. A stack of N microlayers is disposed between the major surfaces and arranged into pairs of adjacent microlayers that exhibit refractive index differences along the x-, y-, and z-axes of Δnₓ, Δn_{y}, and Δn_{z} respectively, where Δnₓ>Δn_{y}>0>Δn_{z}.

U.S. Pat. No. 9,110,245; incorporated herein by reference describes modeled reflection curves that demonstrate the technique of increasing the pass axis reflectivity by increasing the reflectivity of the microlayers along the y-axis. Each curve is the calculated reflectivity for particular multilayer reflective polarizer constructions for p-polarized light incident in the y-z plane as a function of incidence angle in air. Each modeled polarizer construction assumed N total microlayers arranged in a single stack and exposed to air at the outer surface of the first and last microlayer. The N microlayers were arranged in an alternating arrangement of a first and second polymer, with adjacent pairs of the first and second polymer forming optical repeat units with an f-ratio of 50%. The optical repeat units assumed a linear optical thickness profile ranging from 200 nm for the first layer pair (corresponding to a normal incidence reflection peak at 400 nm) to 462 nm for the last layer pair (corresponding to a normal incidence reflection peak at 925 nm). Some modeled (e.g. reflective polarizer) MOF constructions that are suitable for use in the present invention have the following additional properties:

| | MOF1 | MOF2 | MOF3 | MOF4 |
|---|---|---|---|---|
| n1y | 1.61 | 1.61 | 1.61 | 1.61 |
| n1z | 1.505 | 1.505 | 1.505 | 1.505 |
| n2 | 1.61 | 1.595 | 1.564 | 1.564 |
| Δn_{y} | 0 | 0.015 | 0.046 | 0.046 |
| Δn_{z} | .105 | .09 | .059 | .059 |
| N | 275 | 275 | 275 | 175 |

The refractive indices in the x-direction have no effect on the modeling and are not listed. The birefringent refractive indices n1y, n1z that were used are representative of 90/10 coPEN oriented at ˜145° C. at a stretch ratio of about 5:1 at a strain rate of about 5 m/min. The isotropic refractive indices n2 that were used are representative of coPEN 55/45 (for MOF1), a blend of 46% 90/10 coPEN and 54% PETG (for MOF2), and PETG (for MOF3 and MOF4).

Various other multilayer optical films are known in the art. See for example U.S. Pat. Nos. 8,182,924 and 9,046,656; incorporated herein by reference. Various multilayer films including optical films are commercially available from 3M. In some embodiments, the multilayer film may comprise a polyacrylate skin layer such as described U.S. Pat. No. 8,182,924 that may exhibit better adhesion to adhesives comprising (meth)acrylate monomers and/or an acrylic polymer.

Although the exemplified multilayer film has numerous layers of specific refractive indices and differences for the purpose of obtaining certain optical effects, for the present invention the multilayer film may comprise only two layers, or alternating layers of A, B, and optionally C that is much less than 275, as previously described. However, a greater number of layers can be beneficial for energy absorption or providing high interlayer delamination strength that may important for EV battery packs, especially if the vehicle is involved in a crash.

As demonstrated in the forthcoming examples, multilayer (e.g. optical) films comprising thermoplastic (e.g. aromatic) polyester layers can provide reduced cleavage strength relative to the control and retained overlap shear strength.

In yet other embodiments, for article wherein intermediate heat resistance is desired, (e.g. greater than polyolefins, but less than (e.g. aromatic) polyesters) the multilayer film may comprise two or more layers wherein at least one layer comprises a thermoplastic polymer with high heat resistance, such as a polyester and at least one layer comprising a polyolefin, styrenic block copolymer, or mixture thereof. In some embodiments, the multilayer film 1100 comprises an interior layer (e.g. layers 1102 or 1103 of FIG. 11) comprising a polyolefin, styrenic block copolymer, or mixture thereof disposed between exterior layers (1100 and 1104) comprising a thermoplastic polymer with high heat resistance such as a polyester. Suitable polyester(s) and polyolefin materials have previously been described. Various styrenic block copolymers are known in the art. In some embodiments, the styrenic block copolymer is a linear triblock copolymer comprising polystyrene blocks and a polyolefin block, such as ethylene/butylene or ethylene/propylene. In some embodiments, the block copolymer comprises a polystyrene content ranging from about 10% to 15 mole %. The block copolymer may have a melt flow index in the same range as the polyolefins as previously described. In some embodiments, the melt flow (230C/216 g, ASTM D1238) ranges from 2 to 5 g/10 min. In some embodiments, the block copolymer has a tensile strength ranging from about 750 to 3000 psi (ASTM D412). In some embodiments, the block copolymer has a shore hardness ranging from 25 to 50 (ASTM D2240, Shore A (10 seconds). In some embodiments, the block copolymer has an elongation ranging from 300% to 1000% (ASTM D412). The block copolymer may further comprise polystyrene/polyolefin (e.g. ethylene/butylene or ethylene/propylene) diblock.

In some embodiments, the block copolymer comprises a blend of polyolefin (e.g. polypropylene) and styrenic block copolymer (e.g. SEPS) at a weight ratio ranging from 9:1 to 1:9. In some embodiments, the weight ratio is at least 1:1, 2:1, 3:1, 4:1, 5:1, 6:1, 7:1, or 8:1.

Multilayer films of this type are described in U.S. Pat. No. 10,710,343; incorporated herein by reference.

The multilayer film may further comprise additives inorganic fillers such as talc (including epoxy coated talc), colorants, flame retardants (halogenated and non-halogenated) and flame retardant synergists such as Sb₂O₃. In some embodiments, a difference in the amount of inorganic filler within layers of the multilayer film may contribute to the interlayer peel delamination strength. The term “within” refers to a layer below the first major surface of the film and above the second major surface of the film. Notably a layer disposed on a major surface of the film such as a coating is not a layer within the multilayer film. The multilayer film typically comprises at least two layers that differ in crystallinity. In typical embodiments, at least one layer of the multilayer film comprises a crystalline polymer inclusive of semi-crystalline polymer and at least one adjacent layer is significantly less crystalline or amorphous. The difference in crystallinity or birefringence contributes to the interlayer peel delamination strength of the multilayer film. Crystalline polymers are characterized by having a melt temperature that is detectable by Differential Scanning calorimetry ASTM D3418. When a first layer (for example, Layer A) and a second layer (for example, Layer B) are both at least partially crystalline (also referred to herein as crystalline), one of the layers (for example, Layer A) may have greater crystallinity than the other layer (for example, Layer B). When one crystalline layer has greater crystallinity than another layer, the more crystalline layer (also referred to herein as the layer with greater crystallinity) exhibits a greater enthalpy of melting than the other crystalline layer, as measured by DSC. In some embodiments, the difference in enthalpy between adjacent layers that delaminate is the absolute value of at least 5, 10, 15, 20, 25, or 30 J/g.

The multilayer film, alone, has an interlayer peel delamination strength that is the load per unit width when the layers of the multilayer film are peeled apart at 90 degrees orientation, as described in the Film Interlayer Peel Delamination Strength Test Method. The interlayer delamination strength is a property of the multilayer film alone, describing the delamination of directly adjacent polymer layers that are not pressure sensitive adhesives. The test method quantifies the strength of delamination of the multilayer film at an internal interface 23° C. In some embodiments, the multilayer film delaminates at 23° C. at an interface having a interlayer peel delamination strength of at least 10 g/in, at least 50 g/in, at least 100 g/in, at least 200 g/in, or at least 500 g/in. In some embodiments, the multilayer film delaminates at 23° C. at an interface having an interlayer peel delamination strength of no greater than 2500 g/in, 2000 g/in, 1500 g/in, 1000 g/in, 500 g/in, 200 g/in or 100 g/in. Multilayer films with high interlayer peel delamination strength are known; some of which are described in previously cited U.S. Pat. No. 10,710,343.

Bonded articles of the disclosure include the (e.g. multilayer) film at least partially within an adhesive layer between two substrates. The (e.g. multilayer) film contributes to the strength of the bonded article (e.g., the cleavage strength and the overlap shear strength of the article). Although the interlayer peel delamination strength of the multilayer film (property of the film alone), contributes to the strength of the adhesively bonded article, the cleavage strength of the article is not simply the interlayer peel delamination strength of the film. The mechanics of separation of layers during 90 degree peel (e.g., in the Film Interlayer Peel Delamination Strength Test Method) are different from the mechanics of separation of layers during cleavage or overlap shear, for example. Further, other factors including for example the Young's modulus of the adhesive, setback of the adhesive layers, and whether the adhesive layer partially or fully spans the adhesive layer have also been found to be variables with respect to the cleavage strength of the adhesively bonded article. For example, when one or both of the substrates are rigid, the cleavage strength of the bonded article can be significantly greater than the interlayer peel delamination strength of the multilayer film.

Various interlayer peel delamination strengths can be obtained by adjusting crystalline content of the crystalline layer. For example, when the crystalline layer comprises a crystalline polyolefin (e.g. polypropylene) and a (e.g. SEPS) block copolymer at a weight ratio of 9:1 the interlayer delamination peel strength can be about 25 g/inch, as the amount of crystalline polyolefin decreases and the amount of block copolymer increases, the delamination strength increases. When the crystalline layer comprises crystalline polyolefin and block copolymer at a weight ratio of 4:6 the interlayer delamination peel strength can be about 250 g/inch. Higher interlayer peel delamination strength may be obtained by further reducing the amount of crystalline polyolefin and increasing the amount of block copolymer. However, when the crystalline content is too low, the interlayer peel delamination strength may exceed the film strength. In this embodiment, the multilayer film may tear in a direction parallel to the thickness (z-direction), rather than cleave or in other words delaminate in a direction orthogonal to the thickness.

In some embodiments, the bonded article may comprise a multilayer film with the same interlayer delamination strengths between layers. When the layers are thin, the cleavage strength can be the same regardless of the actual location of the delamination.

In some embodiments, the bonded article may comprise a multilayer film with at least two different interlayer delamination strengths. For a multilayer film to have at least two different interlayer delamination strengths, what is meant is that the film includes at least three layers and thus at least two internal interfaces between directly adjacent pairs of layers, and interlayer delamination strengths between at least two pairs of directly adjacent layers are different. In other embodiments, the bonded article may comprise at least two multilayer films with different interlayer delamination strengths.

The multilayer film or films may have a first delamination strength and a second delamination strength that are different from each other by use of different materials in the multilayer film layers. The first delamination strength can differ from the second delamination strength by a factor of, for example, at least 2, 3, 4, 5, 6, 7, 8, 9, or 10.

In some embodiments, the (e,g, multilayer) film comprises tabs, markings, or a combination thereof indicating one or more delamination locations.

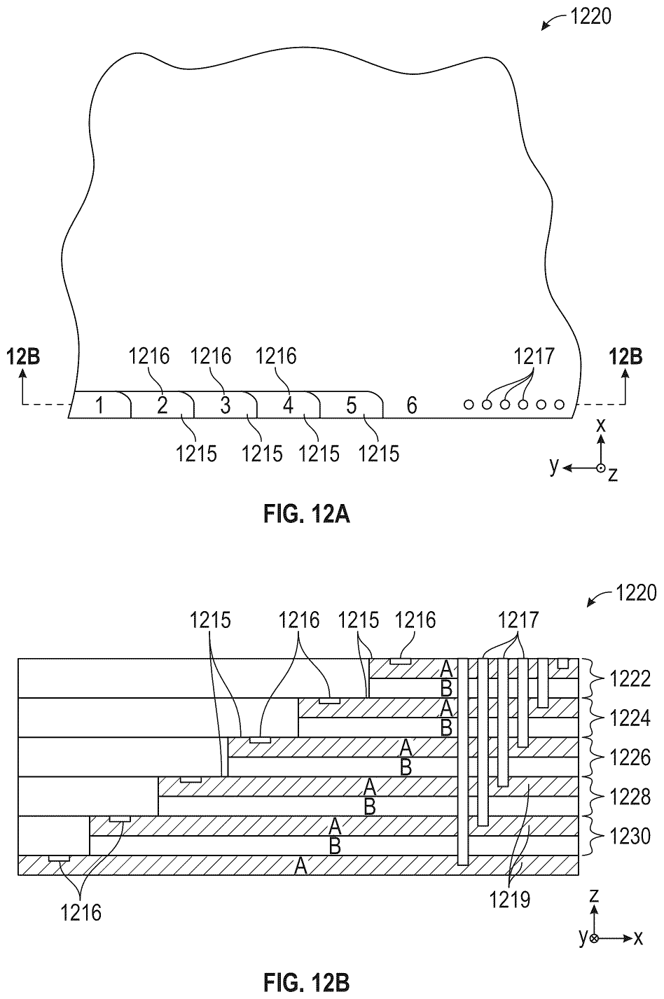

To facilitate a first and subsequent removals of a portion of the layers (i.e. a layer packet) at a time and ensure delamination occurs at interfaces between layer packets, the multilayer film can be made with kiss-cut tab-like features of differing depths near the edge of the film, such as depicted in FIGS. 12A and 12B. These features provide access to the desired delamination surfaces, and thus may be referred to as access tabs.

Access tabs can be formed in any suitable manner. In one embodiment, recessed access tabs can be provided by laser radiation to cut and subdivide polymeric multilayer film without any substantial delamination at the laser cut edge lines, such as described in WO 2012/092478 (Wu et al.). The laser radiation is selected to have a wavelength at which at least some of the materials of the film have substantial absorption so that the absorbed electromagnetic radiation can effectively vaporize or ablate the film body along the cut line. The laser radiation is also shaped with suitable focusing optics and controlled to suitable power levels to accomplish the vaporization along a narrow cut line. The laser radiation can be rapidly scanned across the workpiece according to pre-programmed instructions, and switched on and off rapidly so that cut lines of arbitrary shape can be followed. Alternatively, mechanical blades and other cutting devices can be used instead of laser radiation to form the tab-like features.

In some embodiments, the (e,g. multilayer) film comprises one or more markings for each delamination location. The marking may be a label, indica, alphanumeric characters or other symbols, as well as different colors. Such marking may be provided at the location of a recessed access tab, such as depicted in FIGS. 12A and 12B. Alternatively, such marking may be provided on unbonded multilayer film tabs.

In one embodiment, the markings 1216 are numbers in the region of the access tabs 1215 that can be observed by the user as a convenient indication of how many delamination locations remain in the stack, and on the workpiece. For example, upon delamination and removal of the front-most layer packet 1222, the marking 1216 in the form of a “6” will be removed along with the packet 1222, so that only the markings 1216 in the form of “1”, “2”, “3”, “4”, and “5” will remain visible to the user. The markings 1216 are shown as shallow holes or depressions in the polymer layers A, but they may utilize alternative designs.

In another embodiment, the markings 1217 are holes of different depths. These holes may all open at the exposed surface of the front-most layer and terminate at different layers. The shallowest hole terminates at the front-most layer packet 1222, the next deepest hole terminates at the next layer packet 1224, the next deepest hole terminates at the next layer packet 1226, and so forth (e.g. 1228, 1230). These holes are shown as simple round holes and are non-overlapping and spaced apart from each other along a straight line near an edge of the stack 1220, but other designs can also be used. These markings 1217 can also provide an indication to the user of how many layer packets remain in the stack and on the workpiece. For example, six of the markings 1217 are visible in the plan view of FIG. 12A, but after the outermost layer packet 1222 is peeled away, only five of the markings 1217 will remain, and after the layer packet 1224 is peeled away, only four of the markings as 1217 will remain, and so forth. Although the tabs are depicted along the same edge of the multilayer film, the tabs can be at different (e.g. opposing) edges. When the article comprises two or more multilayer films, each multilayer film may have a tab or tabs located along the same or different edges of the multilayer film.

### Methods of Making Bonded Articles

The adhesive bonded articles can be made by any suitable method. In some embodiments, the adhesive bonded articles are prepared by applying a first adhesive layer to a first substrate; applying a second adhesive layer to a second substrate; and contacting the first and second adhesive layers such that a multilayer film is disposed at least in part between the first and second adhesive layers.

In some embodiments, the multilayer film is applied at least in part to a surface of the first adhesive layer followed by contacting the multilayer film (and first adhesive layer when the multilayer film partially spans the adhesive layer) with the second adhesive layer or vice versa, In this embodiment, the adhesive may be a curable liquid adhesive or a partially cured adhesive layer of a transfer tape. The adhesive layers may be applied with a (e.g. robotic) adhesive dispenser. The multilayer film may be provided in a roll-form that is cut to the desired size before or after bonding.

In other embodiments, at least one of the adhesive layers (e.g. first or second) is pre-applied to one major surface of the multilayer film as a single-faced tape. The adhesive layer of the single faced tape is contacted with the first or second substrate. A curable liquid adhesive or a partially cured adhesive layer of a transfer tape is then applied to the other major surface of the multilayer film or the surface of the other substrate. The assembled layers are then sequentially or concurrently cured.

In another embodiment, the adhesive layers (e.g. first or second) are pre-applied to both major surfaces of the multilayer film as a double-faced tape. When the adhesive layers are structural adhesive layers, the adhesive layers typically comprise a curable composition that initially may be characterized as being a pressure sensitive adhesive, but after curing is no longer a pressure sensitive adhesive in view of having a higher Tg, higher modulus, and lacking peel adhesion properties as previously described.

The liquid curable adhesive or partially cured adhesive layer may be thermally cured or cured by exposure to actinic (e.g. ultraviolet or electron beam radiation).

Thus, adhesive tape articles are also described that comprise a multilayer film, as described herein, and various types and combination of one or more adhesive layers, as described herein.

The (e.g. multilayer) film as well as the substrate to be adhesively bonded may be subjected to customary surface treatments for improving adhesion. Surface treatments include for example exposure to ozone, exposure to flame, exposure to a high-voltage electric shock, treatment with ionizing radiation, and other chemical or physical oxidation treatments. Chemical surface treatments include primers. Examples of suitable primers include chlorinated polyolefins, polyamides, and modified polymers disclosed in U.S. Pat. Nos. 5,677,376, 5,623,010 and those disclosed in WO 98/15601 and WO 99/03907, and other modified acrylic polymers. In one embodiment, the primer is an organic solvent-based primer comprising acrylate polymer, chlorinated polyolefin, and epoxy silane as available from 3M Company as “3M™ Primer 94”. Mechanical abrading or other forms of treatment used to increase surface area can also be used for improving adhesion.

### Adhesive Layers

The adhesive layer(s) can include a wide variety of adhesives depending on the desired heat resistance properties of the adhesively bonded article and method of making such article.

In some embodiments, such as for articles wherein low heat resistance is suitable, the adhesive may comprise a pressure sensitive adhesive. Pressure sensitive adhesives have properties including a Tg less than 25° C. (including less than 0, −20, −40, −60), a shear storage modulus (G′) of less than 3×10⁶ dyne/cm² (0.3 MPa) at room temperature (25° C.) and a frequency of 1 Hz., and sufficient adhesion (e.g. a 90 degree peel strength of the adhesive to aluminum of at least 100, 200 g/inch at 23° C. and a rate of 12 inches per minute.

Pressure sensitive adhesives are often categorized based on their polymer component, e.g. acrylic adhesives, polyurethane adhesives, silicon adhesives, natural and synthetic rubber adhesives, polyolefin adhesives, block copolymer adhesives, etc. When a non-curable pressure sensitive adhesive is utilized, the heat resistance of the bonded article and tape may be limited by the heat resistance (Tg) of the pressure sensitive adhesive.

In other embodiments, wherein higher heat resistance and/or greater bond strength is desired, the adhesive is typically a curable structural adhesive including semi-structural adhesives. In this embodiment, the adhesive(s) layers are not pressure sensitive adhesives (as previously described with respect to the multilayer film). However, in some embodiments, the structural adhesive may initially be pressure sensitive, but not pressure sensitive after curing.

The Young's modulus of the (cured) adhesive is a variable that affects the cleavage strength and overlap shear strength of articles having a multilayer film within the adhesive layer(s). In some embodiments, the Young's modulus of the (cured) adhesive is less than 2000 MPa, 1500 MPa, 1000 MPa, 500 MPa, 250 MPa, 100 MPa, 50 MPa, or 25 MPa. In some embodiments, the Young's modulus of the (cured) adhesive is a least 0.5, 1, 2, 3, 5, 10, 15, 20, 25, 50, 100, 250, 500, 750, 1000, or 1500 MPa.

In some embodiments, a multilayer film having an interlayer delamination strength of greater than 50 g/in is utilized with a (cured) adhesive, wherein the Young's modulus of the (cured) adhesive is less than 1700 MPa. In other embodiments, a multilayer film having an interlayer delamination strength of greater than 100 g/in is utilized with a (cured) adhesive, wherein the Young's modulus of the (cured) adhesive is less than 1000 MPa. In other embodiments, a multilayer film having an interlayer delamination strength of greater than 200 g/in is utilized with a (cured) adhesive, wherein the Young's modulus of the (cured) adhesive is less than 500 MPa.

The (cured) adhesive can be selected from a wide-variety of one-part and two-part structural adhesives that have been described in the art. For example, suitable polyurethane structural adhesives that comprise a polymeric polyol component and an isocyanate component are known. See for example, U.S. Pat. Nos. 5,162,481; 5,606,003; and 8,410,213; and EP-627451; incorporated herein by reference. A representative two-part urethane composition is commercially available from 3M as 3M™ Scotch-Weld™ Multi-Material & Composite Urethane Adhesive DP 6310NS.

In some embodiments, one or more adhesive layers comprise a curable adhesive comprising (meth)acrylate moieties, urethane moieties, epoxy moieties, or combinations thereof; wherein the curable adhesive is cured. In some embodiments, the adhesive further comprises an elastic component (e.g. toughener), such as a synthetic nitrile rubber or styrene block copolymer.

In some embodiments, (curable) adhesive comprises one or more epoxy resins. The epoxy resins or epoxides are organic compounds having at least one oxirane ring that is polymerizable by ring opening, i.e., an average epoxy functionality greater than one, and preferably at least two. The epoxides can be monomeric or polymeric, and aliphatic, cycloaliphatic, heterocyclic, aromatic, hydrogenated, or mixtures thereof. Preferred epoxides contain more than 1.5 epoxy group per molecule and preferably at least 2 epoxy groups per molecule. The useful materials typically have a weight average molecular weight of about 150 to about 10,000, and more typically of about 180 to about 1,000. The molecular weight of the epoxy resin is usually selected to provide the desired properties of the cured adhesive. Suitable epoxy resins include linear polymeric epoxides having terminal epoxy groups (e.g., a diglycidyl ether of a polyoxyalkylene glycol), polymeric epoxides having skeletal epoxy groups (e.g., polybutadiene poly epoxy), and polymeric epoxides having pendant epoxy groups (e.g., a glycidyl methacrylate polymer or copolymer), and mixtures thereof. The epoxide-containing materials include compounds having the general formula:

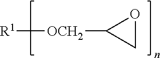

where R1 is an alkyl, alkyl ether, or aryl, and n is 1 to 6.

Epoxy resins include aromatic glycidyl ethers, e.g., such as those prepared by reacting a polyhydric phenol with an excess of epichlorohydrin, cycloaliphatic glycidyl ethers, hydrogenated glycidyl ethers, and mixtures thereof. Such polyhydric phenols may include resorcinol, catechol, hydroquinone, and the polynuclear phenols such as p,p′-dihydroxydibenzyl, p,p′-dihydroxydiphenyl, p,p′-dihydroxyphenyl sulfone, p,p′-dihydroxybenzophenone, 2,2′-dihydroxy-1, 1-dinaphthylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Also useful are polyhydric phenolic formaldehyde condensation products as well as polyglycidyl ethers that contain as reactive groups only epoxy groups or hydroxy groups. Useful curable epoxy resins are also described in various publications including, for example, “Handbook of Epoxy Resins” by Lee and Nevill, McGraw-Hill Book Co., New York (1967), and Encyclopedia of Polymer Science and Technology, 6, p.322 (1986).

Examples of commercially available epoxides include diglycidyl ethers of bisphenol A (e.g. those available under the trade designations EPON 828, EPON 1001, EPON 1004, EPON 1007, EPON 2004, EPON 1510, and EPON 1310 from Momentive Specialty Chemicals, Inc., and those under the trade designations D.E.R. 331, D.E.R. 332, D.E.R. 334, and D.E.N. 439 available from Dow Chemical Co.); diglycidyl ethers of bisphenol F (e.g., that are available under the trade designation ARALDITE GY 281 available from Huntsman Corporation); silicone resins containing diglycidyl epoxy functionality; flame retardant epoxy resins (e.g., that are available under the trade designation DER 560, a brominated bisphenol type epoxy resin available from Dow Chemical Co.); and 1,4-butanediol diglycidyl ethers.

In some embodiments, the adhesive comprises an epoxy resin having an epoxy equivalent weight (EEW) of at least 100, 150, 200, 250, 300, 350, 400, 450, 500, 550, 600, 650, 700, 750, 800, 850, 900, 950, 1000 or a range of EEW having a minimum or maximum from such stated values. In some embodiments, the adhesive comprises an epoxy resin having an epoxy equivalent weight (EEW) of at least 1500, 2000, 2500, 3000, 3500, 4000, 4500, or 5000 or a range of EEW having a minimum or maximum from such stated values. Various combinations of epoxy resin(s) can be used having different ranges of epoxy equivalent weight.

In typical embodiments, the adhesive composition comprises one or more aromatic epoxy resin(s), such as those comprising bisphenol moieties. In other embodiments, a mixture of aromatic epoxy resin and non-aromatic epoxy resin is utilized.

When the adhesive composition further comprises (meth)acrylate monomers, the adhesive composition typically comprises at least 25, 30, 35, or 40 wt. % of epoxy resin(s) based on the total of (meth)acrylate monomers and epoxy resin. In some embodiments, the adhesive composition comprises no greater than 50 wt. % of epoxy resin(s). However, when the adhesive composition lacks (meth)acrylate monomers, the amount of epoxy resin(s) can be greater.

The epoxy adhesive composition typically comprises a hydroxyl-containing component that lacks a (meth)acrylate group. The hydroxyl-containing compound acts as a chain transfer agent when the epoxy groups react according to a cation mechanism. When present the amount of hydroxyl-containing component typically ranges from 5 to 15 wt. % of the adhesive composition.

In some embodiments, the hydroxyl-containing compound is polyol such as a polyether polyol and a polyester polyol. The polyether polyol includes, but is not limited to, one or a plurality from the group consisting of a polyether triol and a polyether diol. Various polyether polyols are known typically having a molecular weight of at least 500, 1000, or 1500, or 2000 g/mole. In some embodiments, the polyether polyol has a molecular weight no greater than 5000, 4000, or 3000 g/mole.

In some embodiment, the epoxy resin adhesive composition further comprises a polymeric toughening agent such as a synthetic rubber, styrenic block copolymers, and core-shell polymers, such as described in U.S. Pat. No. 4,704,331; incorporated herein by reference. In other embodiments, the epoxy resin may be combined with (meth)acrylate monomers that may be partially polymerized.

In some embodiments, the adhesive comprises one or more (meth)acrylate monomers. The (meth)acrylate monomer may be characterized as low or high Tg monofunctional alkyl (meth)acrylate monomers as well as (e.g. acidic and non-acidic) polar monomer. The Tg of the homopolymer of various monomers is known and is reported in various handbooks and by the suppliers of various monomers.

Curable structural adhesive compositions often comprise higher concentrations of one or more (e.g. non-polar, non-acidic) high Tg monofunctional alkyl (meth)acrylate monomers, i.e. a (meth)acrylate monomer when reacted to form a homopolymer has a Tg of at least 25, 30, 35, 40, 45, or 50° C. In some embodiments, a homopolymer of the high Tg monomer has a Tg of at least 55, 60, 65, 70, 75, 80, 85, or 90° C. In some embodiments, the high Tg monomer has a Tg no greater than 125 or 100° C. In some embodiments, the high Tg monomer comprises a cyclic group.

Representative high Tg monomers include t-butyl acrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, norbornyl (meth)acrylate, benzyl methacrylate, 3,3,5 trimethyl cyclohexyl acrylate, cyclohexyl acrylate, t-butyl cyclohexyl acrylate, and propyl methacrylate or combinations.

In some embodiments, such as when the adhesive composition further comprises an epoxy resin, the curable adhesive composition comprises at least 10, 15, 20, 25, 30, 35, 40, 45, or 50 wt. % of high Tg monofunctional alkyl (meth)acrylate monomer(s), based on the total amount of (e.g. polymerized units of) monofunctional (meth)acryl monomers. In some embodiments, the adhesive composition comprises no greater than 50, 45, 40, 35, 30, 25, or 20 wt. % of high Tg monofunctional (meth)acryl monomer(s). When the adhesive composition lacks an epoxy resin, the amount of high Tg monofunctional (meth)acryl monomers may be greater.

In some embodiments, the adhesive composition comprises (e.g. polymerized units of) one or more low Tg (meth)acrylate monomers, i.e. a (meth)acrylate monomer when reacted to form a homopolymer has a Tg no greater than 0° C. In some embodiments, the low Tg monomer has a Tg no greater than −10, −20, −30, −40, −50, or −60° C. The Tg of the homopolymer of the low Tg monomer is often at least −80° C., −70° C., −60° C., or −50° C.

The low Tg monomer is typically a monofunctional alkyl (meth)acrylate monomer having the formula

H₂C═CR¹C(O)OR⁸

wherein R¹ is H or methyl and R⁸ is an alkyl with 4 to 22 carbons. The alkyl group is typically linear or branched. The term “monofunctional” refers to the monomer having one (meth)acrylate group.

Exemplary low Tg monomers monofunctional alkyl (meth)acrylate monomers include for example ethyl acrylate, n-propyl acrylate, n-butyl acrylate (BA), isobutyl acrylate, t-butyl acrylate, n-pentyl acrylate, isoamyl acrylate, n-hexyl acrylate, 2-methylbutyl acrylate, 2-ethylhexyl acrylate (2EHA), 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, and dodecyl acrylate.

In typical embodiments, the adhesive composition comprises (e.g. polymerized units of) low Tg monofunctional alkyl monomer(s) having an alkyl group with 4 to 12 carbon atoms. Exemplary monomers include, but are not limited to, butyl acrylate, 2-ethylhexyl (meth)acrylate, isooctyl acrylate, n-octyl (meth)acrylate, 2-octyl (meth)acrylate, isodecyl (meth)acrylate, and lauryl acrylate.

In some embodiments, the curable adhesive composition comprises high Tg monofunctional alkyl (meth)acrylate monomers and/or epoxy resins in combination with one or more low Tg (meth)acrylate monomers. In this embodiment, the adhesive composition comprises at least 10, 15, 20, 25, 30, 35, 40, 45, or 50 wt. % of (e.g. polymerized units) of low Tg monofunctional alkyl (meth)acrylate monomer(s), based on the total weight of monofunctional (meth)acryl monomer(s). The adhesive composition typically comprises no greater than 70, 65, 60, 55, or 50 wt. % of (e.g. polymerized units of) low Tg monofunctional alkyl (meth)acrylate monomer(s). It is appreciated that the preferred concentration of low Tg monomer(s) is affected by the Tg and concentration of other (meth)acryl monomers of the adhesive composition. In the case of pressure sensitive adhesive that are not semi-structural adhesive, the amount of low Tg monofunctional alkyl (meth)acrylate monomer(s) is typically at least 50, 55, 60, 65, 70 wt.-% or greater. Alternatively or in addition to low Tg monofunctional alkyl monomer(s) the adhesive may comprise a urethane (meth)acrylate oligomer as the low Tg (meth)acrylate monomer

The curable adhesive composition may further comprise (e.g. polymerized units) one or more polar monomers. Representative polar monomers include acid-functional monomers, hydroxyl functional monomers, ether-containing monomers, nitrogen-containing monomers.

Acid functional groups may be an acid per se, such as a carboxylic acid, or a portion may be salt thereof, such as an alkali metal carboxylate. Acid functional monomers include ethylenically unsaturated carboxylic acids, ethylenically unsaturated sulfonic acids, ethylenically unsaturated phosphonic acids, and mixtures thereof. Examples of such compounds include acrylic acid, methacrylic acid, itaconic acid, fumaric acid, crotonic acid, citraconic acid, maleic acid, oleic acid, b-carboxyethyl (meth)acrylate, 2-sulfoethyl methacrylate, styrene sulfonic acid, 2-acrylamido-2-methylpropanesulfonic acid, vinylphosphonic acid, and mixtures thereof.

In some embodiments, such as when the adhesive is intended to adhere to metal, the adhesive composition comprises little or no acid functional monomers to avoid corrosion. Too much acidic monomer can also reduce the shelf life of the tape by activating the epoxy cure prematurely. Thus, in typical embodiment, the amount of acid functional monomer is zero or less than 5, 4, 3, 2, 1, 0.5, 0.1 wt. % of the total amount of (meth)acrylate monomers of the adhesive composition.

In typical embodiments, the adhesive composition comprises little or no nitrogen-containing monomers since such monomers can hinder the cationic epoxy cure. Thus, in typical embodiment, the amount of nitrogen-containing monomer is zero or less than 5, 4, 3, 2, 1, 0.5, 0.1 wt. % of the total amount of (meth)acrylate monomers of the adhesive composition.

In typical embodiments, the adhesive composition comprises non-acidic polar monomer or in other words polar monomer(s) that lack acid and nitrogen groups. One class of non-acidic polar monomers are mono(meth)acrylate monomers comprising ether groups, such as tetrahydrofurfuryl acrylate (THFA).

Another class of non-acidic polar monomers includes hydroxy-functional (meth)acrylate monomers. Representative examples include 2-(2-ethoxyethoxy)ethyl (meth)acrylate, 2-ethoxyethyl (meth)acrylate, 2-hydroxyethyl (meth)acrylate, 2-(methoxyethoxy)ethyl, 2-methoxyethyl methacrylate, 4-hydroxybutyl acrylate, 2-phenoxyethyl acrylate, hydroxypropyl acrylate and polyethylene glycol mono(meth)acrylates.

In some embodiments, the adhesive composition comprises little or no non-acidic polar monomers with aromatic groups, such as 2-phenoxyethyl acrylate. In this embodiment, the amount of aromatic polar monomers is zero or less than 10, 9, 8, 7, 6, 5, 4, 3, 2, 1 wt. % of the total amount of (meth)acrylate monomers of the adhesive composition.

In some embodiments, the polar monomer has a low Tg (i.e. no greater than 0° C.). In some embodiments, the polar monomer has a Tg no greater than −10, −20, −30, −40, or −50° C. The Tg of the homopolymer of the non-acidic polar monomer may be at least −50, −40, −30, −20, or −10° C. Representative examples include tetrahydrofurfuryl acrylate and 2-(2-ethoxyethoxy)ethyl acrylate. Low Tg polar monomer(s) can be used at relatively high concentrations to produce a (meth)acrylic polymer having a Tg less than 0° C.

In some embodiments, the adhesive composition comprises a crosslinker. The crosslinker may comprise free-radically polymerizable groups, such as (meth)acrylate groups. In some embodiments, the crosslinker comprising at least two and typically no greater than 6, 5, 4, or 3 ethylenically unsaturated groups capable of crosslinking polymerized units of the (meth)acrylic polymer.

Examples of useful (e.g. aliphatic) multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, propoxylated glycerin tri (meth)acrylate, and mixtures thereof. Other crosslinkers are described in U.S. Pat. No. 4,330,590; WO2014/172185; WO2015/157350; and WO2020/250154; incorporated herein by reference.

In some embodiments, the adhesive composition comprises an interphase crosslinker that comprises at least one epoxy or hydroxyl group and at least one (meth)acrylate. Such compounds can crosslink the cured epoxy with the (meth)acrylic polymer. Representative crosslinkers include 2-hydroxy-3-phenoxypropyl acrylate (HPPA) and glycidyl methacrylate (GMA). Such interphase crosslinkers may be used in amount of at least 0.5 or 1 wt. % and typically no greater than 10 or 5 wt. % of the total weight of the polymerizable components of the adhesive composition. Notably such crosslinker are typically added after forming a (meth)acrylic copolymer from the monofunctional (meth)acrylate monomers.

With reference to Example 63, the type and amount of polar monomer can be selected to induce phase separation of the adhesive composition. Whereas a compatible single phase adhesive composition (e.g. of a tape having an adhesive layer with a thickness of 10 mils (250 microns) comprising (meth)acrylic polymer and uncured epoxy resin(s)) is clear (i.e. in the absence of opacifying agents such as pigment) the adhesive compositions described herein are translucent or opaque. A compatible single phase adhesive composition typically also has a single Tg after curing of the epoxy resin(s) (as determined by Dynamic Mechanical Analysis as further described in the examples). In contrast, the cured adhesive composition of the present invention can have more than one Tg.

In some embodiments, the adhesive composition comprises a first Tg in a range from −10° C. to 50° C. In some embodiments, the first Tg is at least-15,-10,-5, 0, 5, 10, 15, 20, 25, 30, 35, or 40° C. In some embodiments, the first Tg is no greater than 35, 30, 25, 20, 15, 10, 5, or 0° C. In some embodiments, the adhesive composition has a tan (8) at the first Tg temperature of less than 0.85, 0.80, 0.75, 0.70, 0.65, or 0.60. In some embodiments, the adhesive composition has a tan (8) at the first Tg temperature of at least 0.2, 0.3, or 0.4.

In some embodiments, the adhesive composition comprises a second Tg of at least 50, 55, 60, 65, 70, 75° C. In some embodiments, the second Tg is no greater than 85, 80, 75, 70, 65° C. In some embodiments, the adhesive composition has a tan (8) at the second Tg temperature of less than 0.50, 0.40, or 0.30. In some embodiments, the adhesive composition has a tan (8) at the first Tg temperature of at least 0.1, 0.15, or 0.2. Thus, the adhesive composition has more than one phase and may also be characterized as an interpenetrating polymer network.

Additional suitable compositions comprising an epoxy resin and (e.g. partially polymerized) (meth)acrylate monomers that are suitable for making an adhesive layer for a transfer tape or tape comprising the multilayer film as a backing are described in PA100568US01; incorporated herein by reference.

The adhesive composition may optionally comprise various additives such as fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, etc.

In some embodiments, a layer that delaminates comprise no greater than 30, 25, 20, 15, 10, 5, 2 or 1 wt. % inorganic pigments such as carbon black, titanium dioxide, phthalocyanine blue, and combinations thereof.

Notably thermally conductive adhesives often comprise thermally conductive particles.

The adhesive composition can be polymerized by various techniques, such as described in WO2016/195970 (Shafer et al); incorporated herein by reference. In some embodiments, the adhesive is polymerized by solventless radiation polymerization, including processes using electron beam, gamma, and especially ultraviolet light radiation. In this (e.g. ultraviolet light radiation) embodiment, generally little or no methacrylate monomers are utilized. Thus, the adhesive composition comprises zero or no greater than 10, 9, 8, 7, 6, 5, 4, 3, 2, or 1 wt. % of (e.g. polymerized units of) monomers having a methacrylate group.

One method of preparing the adhesive composition comprises dissolving the epoxy resin(s) in a liquid polyol and combining this mixture with the (meth)acrylate monomers. Such monomers may be partially polymerized. Partial polymerization provides a coatable solution of the (meth)acrylic solute polymer in one or more free-radically polymerizable solvent monomers.

The adhesive composition comprises one or more free-radical initiators (e.g. photoinitiators) and cationic initiators in an amount of at least 0.1, 0.2, 0.3, 0.4 or 0.5 wt. % and typically no greater than 1 wt. % of the total adhesive composition. The initiator may be added immediately prior to use of the adhesive composition in a method of bonding.

The adhesive composition typically comprises a free-radical initiator to polymerize the (meth)acrylate monomers.

The free-radical initiator may be a thermal initiator or a photoinitiator of a type and amount effective to polymerize the (meth)acrylic portion of the second polymerizable material. The initiators are typically employed at concentrations ranging from about 0.0001 to about 3.0 parts by weight, preferably from about 0.001 to about 1.0 parts by weight, and more preferably from about 0.005 to about 0.5 parts by weight of the composition.

Suitable thermal initiators include but are not limited to those selected from the group consisting of azo compounds such as VAZO 64 (2,2′-azobis(isobutyronitrile)), VAZO 52 (2,2′-azobis(2,4-dimethylpentanenitrile)), and VAZO 67 (2,2′-azobis-(2-methylbutyronitrile)) available from Chemours (Wilmington, DE, USA), peroxides such as benzoyl peroxide and lauroyl peroxide, and mixtures thereof. A preferred oil-soluble thermal initiator is (2,2′-azobis-(2-methylbutyronitrile)).

Examples of useful photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); 1-hydroxy cyclohexyl phenyl ketone; and acylphosphine oxide derivatives and acylphosphonate derivatives (e.g., bis(2,4,6-trimethylbenzoyl)phenylphosphine oxide, diphenyl-2,4,6-trimethylbenzoylphosphine oxide, isopropoxyphenyl-2,4,6-trimethylbenzoylphosphine oxide, or dimethyl pivaloylphosphonate). Many photoinitiators are available, for example, from IGM Resins (Charlotte, NC, USA) under the trade designation “OMNIRAD”. The photoinitiator may be selected, for example, based on the desired wavelength for curing and compatibility with the monomers.

In some embodiments, the cationic initiator may be characterized as a photoacid generator. Upon irradiation with light energy, photoacid generators undergo a fragmentation reaction and release one or more molecules of Lewis or Bronsted acid that induce polymerization of the epoxide groups. Useful photoacid generators are thermally stable, do not undergo thermally induced reactions with the composition, and are readily dissolved or dispersed in the composition. Typical photoacid generators are those in which the incipient acid has a pKa value of <0. Photoacid generators are known and reference may be made to K. Dietliker, Chemistry and Technology of UV and EB Formulation for Coatings, Inks and Paints, vol. III, SITA Technology Ltd., London, 1991. Further reference may be made to Kirk-Othmer Encyclopedia of Chemical Technology, 4th Edition, Supplement Volume, John Wiley and Sons, New York, 1992, pp 253-255.

Cations useful as the cationic portion of ionic photoinitiators include organic onium cations, for example those described in U.S. Pat. Nos. 4,250,311, 3,708,296, 4,069,055, 4,216,288, 5,084,586, 5,124,417, 5,554,664 and such descriptions incorporated herein by reference, including aliphatic or aromatic Group IVA VIIA (CAS version) centered onium salts, preferably I-, S-, P-, Se- N- and C-centered onium salts, such as those selected from, sulfoxonium, iodonium, sulfonium, selenonium, pyridinium, carbonium and phosphonium, and most preferably I-, and S-centered onium salts, such as those selected from sulfoxonium, diaryliodonium, triarylsulfonium, diarylalkylsulfonium, dialkylarylsulfonium, and trialkylsulfonium wherein “aryl” and “alkyl” are as defined and having up to four independently selected substituents. The substituents on the aryl or alkyl moieties will preferably have less than 30 carbon atoms and up to 10 heteroatoms selected from N, S, non-peroxidic O, P, As, Si, Sn, B, Ge, Te, Se. Examples include hydrocarbyl groups such as methyl, ethyl, butyl, dodecyl, tetracosanyl, benzyl, allyl, benzylidene, ethenyl and ethynyl; hydrocarbyloxy groups such as methoxy, butoxy and phenoxy; hydrocarbylmercapto groups such as methylmercapto and phenylmercapto; hydrocarbyloxycarbonyl groups such as methoxycarbonyl and phenoxycarbonyl; hydrocarbylcarbonyl groups such as formyl, acetyl and benzoyl; hydrocarbylcarbonyloxy groups such as acetoxy and cyclohexanecarbonyloxy; hydrocarbylcarbonamido groups such as acetamido and benzamido; azo; boryl; halo groups such as chloro, bromo, iodo and fluoro; hydroxy; oxo; diphenylarsino; diphenylstilbino; trimethylgermano; trimethylsiloxy; and aromatic groups such as cyclopentadienyl, phenyl, tolyl, naphthyl, and indenyl. With the sulfonium salts, it is possible for the substituent to be further substituted with a dialkyl- or diarylsulfonium cation; an example of this would be 1,4-phenylene bis(diphenylsulfonium).

Useful onium salt photoacid generators include diazonium salts, such as aryl diazonium salts; halonium salts, such as diarlyiodonium salts; sulfonium salts, such as triarylsulfonium salts, such as triphenyl sulfonium triflate; selenonium salts, such as triarylselenonium salts; sulfoxonium salts, such as triarylsulfoxonium salts; and other miscellaneous classes of onium salts such as triaryl phosphonium and arsonium salts, and pyrylium and thiopyrylium salts.

Ionic photoacid generators include, for example, bis(4-t-butylphenyl) iodonium hexafluoroantimonate (FP5034™ from Hampford Research Inc., Stratford, CT, USA), a mixture of triarylsulfonium salts (diphenyl(4-phenylthio) phenylsulfonium hexafluoroantimonate, bis(4-(diphenylsulfonio)phenyl) sulfide hexafluoroantimonate) available as Syna PI-6976™ from Synasia, Metuchen, NJ, USA, (4-methoxyphenyl)phenyl iodonium triflate, bis(4-tert-butylphenyl) iodonium camphorsulfonate, bis(4-tert-butylphenyl) iodonium hexafluoroantimonate, bis(4-tert-butylphenyl) iodonium hexafluorophosphate, bis(4-tert-butyl phenyl) iodonium tetraphenylborate, bis(4-tert-butyl phenyl) iodonium tosylate, bis(4-tert-butylphenyl) iodonium triflate, ([4-(octyloxy)phenyl]phenyliodonium hexafluorophosphate), ([4-(octyloxy)phenyl]phenyliodonium hexafluoroantimonate), (4-isopropylphenyl) (4-methylphenyl) iodonium tetrakis(pentafluorophenyl) borate (available as Rhodorsil 2074™ from Bluestar Silicones, East Brunswick, NJ, USA), bis(4-methylphenyl) iodonium hexafluorophosphate (available as Omnicat 440 from IGM Resins, Charlotte, NC, USA), 4-(2-hydroxy-1-tetradecycloxy)phenyl]phenyl iodonium hexafluoro-antimonate, triphenyl sulfonium hexafluoroantimonate (available as CT-548 from Chitec Technology Corp. Taipei, Taiwan), diphenyl(4-phenylthio)phenylsulfonium hexafluorophosphate, bis(4-(diphenylsulfonio)phenyl) sulfide bis(hexafluorophosphate), diphenyl(4-phenylthio)-phenylsulfonium hexafluoroantimonate, bis(4-(diphenylsulfonio)phenyl) sulfide hexafluoro-antimonate, and blends of these triarylsulfonium salts available from Synasia under the trade designations of Syna PI-6992 and Syna PI-6976 for the PF6 and SbF6 salts, respectively.

A preferred photoacid generator in a triaryl sulfonium hexafluoroantimonate salt obtained as a 50% solution in propylene carbonate under the designation “UVI6976” from Aceto Corporation (Port Washington, NY, USA). This solution may be dried to yield the pure solid salt, which is also a preferred photoacid generator.

In some embodiments, an adhesive article including adhesive coating films and tape is described comprising a multilayer film and at least one adhesive layer.

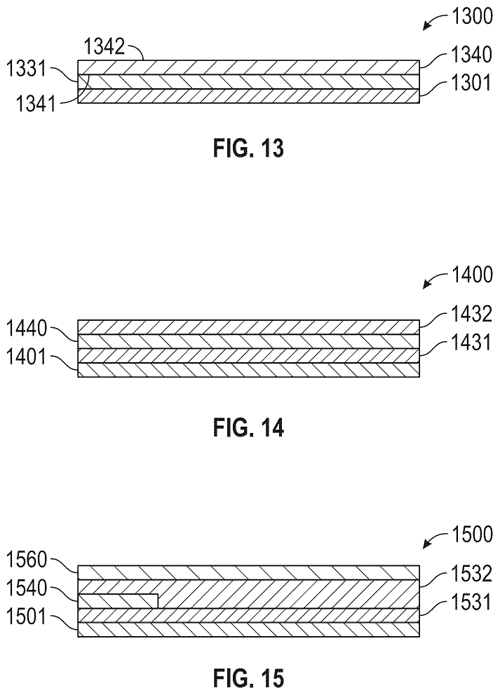

FIG. 13 is a cross-section of a representative adhesive article (e.g. tape) 1300 comprising a multilayer film 1340 with a first major surface 1341 and an opposing major surface 1342. A first adhesive layer 1331 is disposed on the first major surface 1341 of the multilayer film 1340. The multilayer film 1340 fully spans the first adhesive layer 1331. The multilayer film may be characterized as an insulting layer. When first adhesive layer 1331 is pressure sensitive (e.g. prior to curing), a removable release liner 1301 may be disposed on the opposing surface of the adhesive layer.

FIG. 14 is a cross-section of another representative adhesive article 1400 (e.g. tape) comprising a multilayer film 1440 with a first major surface and an opposing major surface. A first adhesive layer 1431 is disposed on the first major surface of the multilayer film. The multilayer film 1440 fully spans the first adhesive layer 1431. The multilayer film may be characterized as an insulting layer. When first adhesive layer 1431 is pressure sensitive adhesive (e.g. prior to curing), a removable release liner 1401 may be disposed on the opposing surface of the adhesive layer. In this embodiment, a second adhesive layer 1432 is disposed on the opposing surface of the multilayer film.

FIG. 15 is a cross-section of another representative adhesive article 1500 (e.g. tape) comprising a multilayer film 1540 with a first major surface and an opposing major surface. A first adhesive layer 1531 is disposed on the first major surface of the multilayer film. The multilayer film 1540 partially spans the first adhesive layer 1531. When first adhesive layer 1531 is pressure sensitive (e.g. prior to curing), a removable release liner 1501 may be disposed on the opposing surface of the adhesive layer. In this embodiment, a second adhesive layer 1532 is disposed on the opposing surface of the multilayer film bonding insulting layer 1560. Insulting layer 1560 may be a monolithic or multilayer film, such as a multilayer film as described herein. The monolithic film may comprise a thermoplastic polymer as described herein. In another embodiment, a third adhesive layer may be disposed on the top surface of insulating layer 1560. The third adhesive layer may comprise be a pressure sensitive adhesive (e.g. prior to curing). In this embodiment, 1532 may be a structural adhesive as described herein that is not pressure sensitive.

### EXAMPLES

Unless otherwise noted or readily apparent from the context, all parts, percentages, ratios, etc. in the Examples and the rest of the specification are by weight. The following abbreviations are used in this section: g-grams, gf-grams force, kg-kilograms, nm-nanometers, μm=micrometers, mm=millimeters, cm=centimeters, in=inch, MPa=megaPascals, ° C.=degrees Celsius, ° F.=degrees Fahrenheit, d=days, h=hours, min=minutes, N=Newtons, kN=kiloNewtons, mJ=milliJoules, mbar=millibars, UV=ultraviolet, V=volts. The units expressed in inches can be converted to cm by multiplying by 2.54.

### Test Methods

All the tests (e.g. cleavage, overlap shear, film interlayer peel delamination strength, Young's modulus) were conducted at ambient temperature (23° C.). For the cleavage strength test methods, the substrates comprise an orthogonal portion (e.g. 375, 475, 575, 675, 2075) that is attached to the grip of the instrument.

### Cleavage Strength Test Method 1

Test samples according to FIGS. 3 and 4 were fabricated using first and second rigid aluminum substrates machined from 6061 alloy of aluminum, illustrated in FIG. 7. For the control samples, the adhesive layer between the first and second aluminum substrates included only a structural adhesive. For the examples, the adhesive layer included a multilayer film approximately centered within the adhesive layer (in the thickness direction z) between the first and second aluminum substrates.

Fully spanning multilayer film samples were prepared with the multilayer film present across the entire area (in the lateral directions x and y) of the adhesive layer.

Edge localized samples were prepared with the multilayer film only being present in a portion of the adhesive layer at a cross sectional penetration distance of an indicated amount in with respect to FIG. 4.

The samples were formed using two blocks of polytetrafluoroethylene (PTFE) that had each been machined with a pocket for receiving a substrate, holes for receiving pins to align the two substrates, and channels for transporting excess adhesive from the adhesive layer during closure. The surfaces of the substrates were grit blasted with aluminum oxide 220 grit abrasive and then wiped with methyl ethyl ketone solvent. Each of two substrates was pressed into the pocket of a block of PTFE at a depth to achieve a target adhesive layer thickness after curing of approximately 3 mm. When the multilayer film was fully embedded, the multilayer film was in the middle of the adhesive layer (1.5 mm of adhesive on each side of the multilayer. Mixed two-part adhesive was dispensed as a layer onto each of the exposed substrate surfaces. For the examples, a piece of multilayer film measuring approximately 1⅝ in by 5 in (extending beyond the eventual adhesive layer area) was placed atop one of the dispensed adhesive layers. The two PTFE blocks with substrates and dispensed adhesive were pressed together to bring the PTFE blocks together and forming a curing assembly. The curing assembly was placed into an oven at 60° C. for 1 h to begin curing the adhesive, followed by further curing at room temperature for at least one day. The controls were prepared the same way except that the multilayer film was excluded.

The excess cured adhesive was trimmed using a blade or cutoff wheel. The cleavage strength of the test samples was determined by mounting each on a load frame (Model Criterion C43, MTS Systems Corporation, Eden Prairie, Minnesota with a 10 kN load cell) using 30 kN wedge-action tension grips with textured wedge faces (MTS Systems Corporation) to engage the short arms (those including holes), loading the sample in tension at a rate of 1.3 in per min. The average cleavage strength N/inch (2.54 cm) of three samples is reported +/−one standard deviation, except where noted otherwise. The cleavage strength was calculated as the maximum load (N) for the 1 inch width.

Cleavage Strength Test Method 2 Test samples according to FIGS. 5 and 6 were fabricated according to the same procedure as described for Cleavage Strength Test Method 1, except that shims of PTFE were placed in a 1 in by 1 in region between the substrates (as illustrated in FIGS. 5 and 6) to occlude adhesive from that region. Thus, the adhesive layer was set back 1 inch relative to the outer edge of the substrates. The Test Method 2 cleavage strength was determined using a load frame and is reported in the same manner as described for Cleavage Test Method 1.

### Cleavage Strength Test Method 3

Test samples were fabricated according to Cleavage Strength Test Method 1, except that one of the substrates was replaced by a less rigid, more deformable L-shaped substrate than the rigid substrate shown in FIG. 7. The replacement substrate had a 4 in leg, a 2 in leg, and width of 1 in, the same leg and width dimensions as the rigid substrate shown in FIG. 7. The single replacement substrate had a thickness of 0.9 mm (vs. the 0.25 in thickness shown in FIG. 7 for the rigid substrate) and was formed by bending a 1 inch by 6 inch sized 0.9 mm thick sheet of 5052 alloy of aluminum. The Test Method 3 cleavage strength was determined using a load frame and is reported in the same manner as described for Cleavage Test Method 1. The replacement substrate deformed during the application of load to the article.

### Overlap Shear Strength Test Method 1

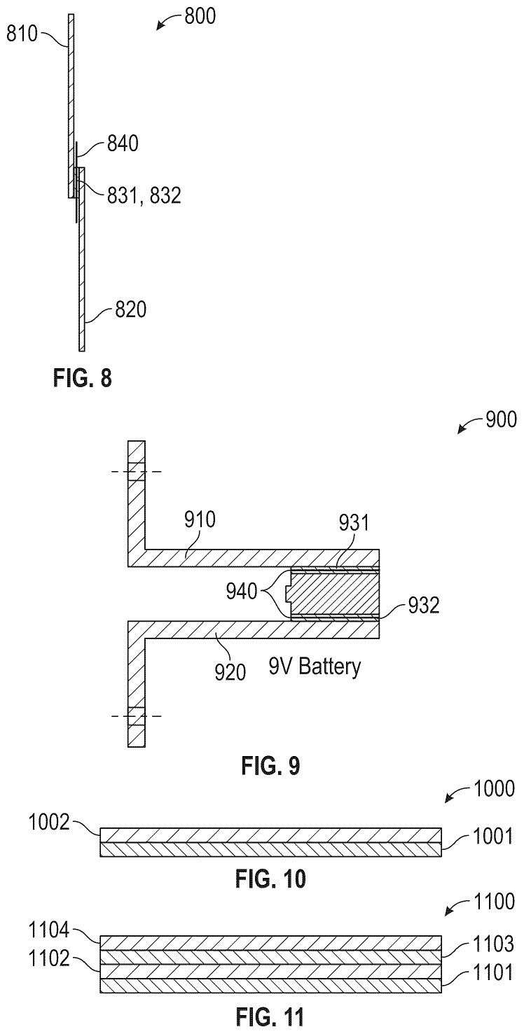

Test samples 800 according to FIG. 8 was fabricated using 1.6 mm thick flat rectangular substrates (810, 820) of 6061 alloy of aluminum measuring 4 in by 1 in. The bond surface of the substrates were grit blasted with aluminum oxide 220 grit abrasive and then cleaned by immersing briefly in heptane, followed by spraying and wiping with a mixture (50/50 by volume) of isopropyl alcohol and deionized water, followed by drying. The controls (not shown) included only a structural adhesive between the substrates while the examples included a multilayer film 840 approximately centered within the adhesive layer (831, 832) and spanning the adhesive layer. For samples not including a film in the adhesive layer, uncured adhesive was dispensed (using a static mixing nozzle) onto one of the substrates with an adhesive thickness of greater than 1 mm. The adhesive layer thickness was set by sprinkling into the adhesive layer glass beads (about 3-25 beads) measuring 0.85 mm in diameter and below by sieving a wider size distribution of commercially available glass beads (obtained under the trade designation P-047 with U.S. screen size of 16-25 from Potters Industries Inc., Carlstadt, New Jersey).

The second substrate was placed onto the adhesive layer targeting an adhesive layer area of approximately one half in by one in, and then clamped to the first substrate using binder clips. The curing assembly was placed into an oven at 60° C. for 1 h to begin curing the adhesive, followed by further curing at room temperature for at least one day.

For samples including a film in the adhesive layer, uncured adhesive was first dispensed (using a static mixing nozzle) onto one of the substrates with a thickness of greater than 0.5 mm. The adhesive layer thickness was set by sprinkling into the adhesive layer commercially available glass beads with an average size of 0.365 mm (obtained under the trade designation P-0170 with U.S. screen size of 40-50 from Potters Industries Inc., Carlstadt, New Jersey) before placing the plasma treated co-extruded multilayer film (cut to 1.625 in×1.5 in) upon the adhesive. A flat 1.6 mm thick rectangular piece of 6061 alloy of aluminum was then placed on top of the multilayer film and secured in place with a binder clip to ensure a uniform and flat bond between the first substrate and multilayer film. This assembly was then put into the oven at 60° C. for 10 min for the adhesive to reach the gel point at which point the binder clip and rectangular aluminum piece were removed, exposing the multilayer film.

The second aluminum substrate was bonded to the exposed surface of the multilayer film with the adhesive using a PTFE jig machined with pockets for receiving both substrates and securing them into place. The jig was used to bond the samples such that there was a consistent ½ inch overlap. This was done in the same manner as described above for the first substrate except that the assembly was placed into an oven at 60° C. for 1 h to begin curing the adhesive. Excess cured adhesive was trimmed using a blade, followed by further curing at room temperature for at least one day.

The overlap shear separation force of the samples was determined by mounting each on a load frame (Model Criterion C43, MTS Systems Corporation, Eden Prairie, Minnesota with a 10 kN load cell) using 30 kN wedge-action tension grips with textured wedge faces (MTS Systems Corporation). Samples were loaded in tension at a rate of 2.5 mm/min (imposing shear stress on the adhesive bond). The maximum load was recorded. After separation, the dimensions of the bond which had been revealed were measured using a ruler and the bond area was calculated. The maximum load was divided by the calculated bond area to yield the overlap shear strength of the adhesive. The average strength of two or three samples +/−one standard deviation is reported.

### Film Interlayer Peel Delamination Strength Test Method

Multilayer films were characterized for their interlayer peel delamination strength at 23° C. as follows. The multilayer film under study was cut to a size of approximately 1 in by 10 in. Next, pieces of filament tape (3M 898) measuring approximately 1 in by 3 in were applied to each side of the multilayer film, taking care not to allow the filament tape to extend past the edges of the multilayer film and adhere to each other. A portion of filament tape (“tab”) was allowed to extend from the multilayer film sample on one short edge of the sample, to enable peeling later. Next, double-sided adhesive (details available) was used to adhere the multilayer film (side not including the tab) to a peel tester (Model 2100, IMASS, Incorporated, Strongsville, Ohio). The tab was engaged by the peel tester and peeling motion was started at 12 in per min. As layers of the multilayer film were separated in the 90 degree peel mode, the peel force was recorded. The average force during continuous peel separation of the layers was recorded as the Film Interlayer Peel Delamination Strength in units of grams per inch (width), g/in.

### Adhesive Young's Modulus Measurement Method

Sheets of each adhesive were cast between release liners using a notch bar coater to a defined thickness of approximately 1 mm. The sheets were placed into an oven at 60° C. for 1 h to begin curing the adhesive, followed by further curing at room temperature for at least one day. Following this, a die cutter was used to cut dog bone tensile samples with a neck width of 6 mm and a gauge length of 45 mm. The samples were then mounted into a load frame (Model Criterion C43, MTS Systems Corporation, Eden Prairie, Minnesota with a 10 kN load cell) using 30 kN wedge-action tension grips with textured wedge faces (MTS Systems Corporation). Samples were then loaded in tension at a rate of 1.3 mm/min to match the strain rate of cleavage samples. Young's modulus was determined using a software (MTS TestSuite™ TW Elite™) linear fit of the elastic portion of the resulting stress v. strain curve at the strain rate of interest.

### Materials

| | |
|---|---|
| DP420NS | Two-part epoxy structural adhesive sold under the trade |
| | designation Scotch-Weld ™ DP420NS (3M Company, St. |
| | Paul, Minnesota) |
| DP8710NS | Two-part acrylic structural adhesive sold under the trade |
| | designation Scotch-Weld ™ DP8710NS (3M Company, St. |
| | Paul, Minnesota) |
| DP8610NS | Two-part acrylic structural adhesive sold under the trade |
| | designation Scotch-Weld ™ DP8610NS (3M Company, St. |
| | Paul, Minnesota) |

### Materials of Adhesive Compositions

| THFA | Tetrahydrofurfuryl acrylate (San Esters, New York NY) |
|---|---|
| IBOA | Isobornyl acrylate (Chempoint, a Univar Company, |
| | Calumet City, IL) |
| 2EHA | 2-ethylhexyl acrylate (BASF, Ludwigshafen Germany) |
| OM651 | Benzyldimethyl ketal photoinitiator obtained under |
| | the trade designation OMNIRAD 651 (iGM Resins |
| | USA, Charlotte, NC, USA) |
| OM819 | Bis(2,4,6-trimethylbenzoyl)-phenylphosphineoxide |
| | photoinitiator obtained under the trade designation |
| | OMNIRAD 819 (iGM Resins USA) |
| HDDA | Hexanediol diacrylate crosslinker (Allnex USA Inc., |
| | Alpharetta GA) |
| EPON | epoxy resin comprised of diglycidyether of bisphenol |
| 828 | A (EEW 185-195 g/eq) (Momentive Specialty Chemicals, |
| | Inc., Columbus, OH) |
| EPON | epoxy resin comprised of diglycidyether of bisphenol |
| 1001 | A (EEW 525-550 g/eq) (Momentive Specialty Chemicals, |
| | Inc.) |
| GPTMS | 3-(Glycidoxypropyl) Trimethoxysilane (Chemical |
| | Technologies, Levittown PA) |
| UVI6976 | Triaryl-sulfonium hexafluoroantimonate, 50 wt % in |
| | propylene carbonate cationic initiator (Aceto |
| | Corporation, Port Washington NY) |
| ACCLAIM | Polyether polyol (Covestro, LLC, Leverkusen Germany) |
| 2200 | |

Multilayer Optical Film (MOF) prepared from alternating layers of 90/10 coPEN and a blend of 46% 90/10 coPEN and 54% PETG, as described above as MOF2. The film had 275 layers wherein each layer had a thickness of 70-100 nm.

### Materials of Multilayer Films

| | |
|---|---|
| PET-1 | Poly(ethyleneterephthalate) with designation “PTA Clear |
| | 62” (3M Company, St. Paul, Minnesota) |
| SEPS | Styrene ethylene propylene styrene sold under the trade |
| | designation KRATON 1645 (Kraton Corporation, Houston, |
| | Texas) |
| PP | Polypropylene raw material sold under the trade designation |
| | Pro-fax SR549M (Lyondell Basell, Houston, Texas) |
| PETG | Polyester co-polymer sold under trade designation Eastar |
| | GN071 (Eastman Chemical, Kingsport, Tennessee) |

### Preparation of Multilayer Films

A series of coextruded multilayer films was prepared according to the methods described in U.S. Pat. No. 10,710,343 with different levels of film interlayer peel delamination strength. The films comprised four layers. Layer 1 was poly(ethylene terephthalate) with thickness of approximately 32 μm, also referred to herein as PET-1. Layer 2 was a styrene ethylene propylene styrene (SEPS) block copolymer with thickness of approximately 12 μm. Layer 3 was a blend of polypropylene (PP) and SEPS with thickness of approximately 12 μm. Layer 4 was an amorphous poly(ethyleneterephthalate) copolymer, also referred to herein as PETG, with thickness of approximately 12 μm. The weakest interface in the films was the interface between Layer 3 and Layer 4. The weakest interface is the interface that opens during mechanical separation. The different multilayer films varied in their ratio of PP to SEPS in Layer 3, as listed in Table 1, resulting in differences in their film interlayer peel delamination strength, also in Table 1. The “9010” film was collected with a liner film applied to its PETG surface. The “7030” and “4060” films were collected with a liner film applied to each of its surfaces. Liner(s) were removed before including films in structural adhesive joints. Before applying adhesive, the exposed surfaces (PET and PETG) were plasma treated for 2 min at a power setting of 100 and air chamber pressure of a 0.1 mbar in a plasma cleaning system (Model Atto, Diener electronic GmbH, Ebhausen, Germany).

TABLE 1
Coextruded multilayer films of examples

| Film | Layer 3 PP:SEPS | Film Interlayer Peel |
|---|---|---|
| Designation | Weight Ratio | Delamination Strength (g/in) |
| 9010 | 9:1 | 22 |
| 7030 | 7:3 | 72 |
| 4060 | 4:6 | 250 |
| MOF | N/A | 599 |

TABLE 2
Youngs Modulus of Adhesive and Cleavage Strength for Controls
C1-C12 (NO multilayer film embedded in the adhesive layer).

| | Cleavage | | Young's | |
|---|---|---|---|---|
| | Strength | | Modulus of the | Cleavage |
| | Test | Adhesive | Adhesive | Strength |
| Example No. | Method | Material | Material (MPa) | (N/inch) |
| C1 | 1 | DP420NS | 1720 | 4457 +/− 301 |
| C2 | 1 | DP8710NS | 159 | 5050 +/− 577 |
| C3 | 1 | DP8610NS | 3.12 | 3267 +/− 369 |
| C4 | 2 | DP420NS | 1720 | 1161 +/− 432 |
| C5 | 2 | DP8710NS | 159 | 2844 +/− 128 |
| C6 | 2 | DP8610NS | 3.12 | 1924 +/− 89 |
| C7 | 3 | DP420NS | 1720 | 1205 +/− 186 |

The sample preparation and test methods described above were conducted with the multilayer films of Table 1 and three different adhesive compositions. The test results are described in the following tables.

The cleavage strength is also expressed as a percentage of the cleavage strength measured for the control having the same adhesive but without the multilayer film.

TABLE 3
Measured cleavage strength for Examples 7-28 having reported
fully embedded multilayer film and reported adhesive

| | Cleavage Strength | Adhesive | Embedded | Cleavage | Relative Cleavage |
|---|---|---|---|---|---|
| Example No. | Test Method | Material | Multilayer Film | Strength (N/inch) | Strength (% of control) |
| 7 | 1 | DP420NS | 9010 | 729 +/− 353 | 16.4% |
| 8 | 1 | DP420NS | 7030 | 1346 +/− 409 | 30.2% |
| 9 | 1 | DP420NS | 4060 | 1204 +/− 145 | 27.0% |
| 10 | 1 | DP8710NS | 9010 | 899 +/− 179 | 17.8% |
| 11 | 1 | DP8710NS | 7030 | 1002 +/− 342 | 19.8% |
| 12 | 1 | DP8710NS | 4060 | 1604 +/− 186 | 31.8% |
| 13 | 1 | DP8610NS | 9010 | 378 +/− 19 | 11.6% |
| 14 | 1 | DP8610NS | 7030 | 708 +/− 367 | 21.7% |
| 15 | 1 | DP8610NS | 4060 | 1505 +/− 151 | 46.1% |
| 16 | 2 | DP420NS | 9010 | 126 +/− 65 | 10.9% |
| 17 | 2 | DP420NS | 7030 | 287 +/− 36 | 24.7% |
| 18 | 2 | DP420NS | 4060 | 363 +/− 57 | 31.3% |
| 19 | 2 | DP8710NS | 9010 | 40 +/− 40 | 1.4% |
| 20 | 2 | DP8710NS | 7030 | 396 +/− 110 | 13.9% |
| 21 | 2 | DP8710NS | 4060 | 576 +/− 57 | 20.3% |
| 22 | 2 | DP8710NS | MOF | 1104 +/− 233 | 38.8% |
| 23 | 2 | DP8610NS | 9010 | 318 +/− 182 | 16.5% |
| 24 | 2 | DP8610NS | 7030 | 310 +/− 52 | 16.1% |
| 25 | 2 | DP8610NS | 4060 | 713 +/− 66 | 37.1% |
| 26 | 3 | DP420NS | 9010 | 194 +/− 9 | 16.1% |
| 27 | 3 | DP420NS | 7030 | 257 +/− 87 | 21.4% |
| 28 | 3 | DP420NS | 4060 | 537 +/− 88 | 44.5% |

TABLE 4
Cleavage strength for Examples 26-49 having the reported
edge-localized embedded multilayer film and reported adhesive

| | Cleav- | | Embed- | Film | | Relative |
|---|---|---|---|---|---|---|
| | age | | ded | Pene- | | Cleavage |
| Ex- | Strength | | Multi- | tration | Cleavage | Strength |
| am- | Test | Adhesive | layer | Distance | Strength | (% of |
| ple | Method | Material | Film | (in) | (N/inch) | control) |
| 26 | 1 | DP420NS | 9010 | 0.5 | 1947 +/− 464 | 43.7% |
| 27 | 1 | DP420NS | 9010 | 1.0 | 1427 +/− 506 | 32.0% |
| 28 | 1 | DP420NS | 9010 | 1.5 | 1790 +/− 847 | 40.2% |
| 29 | 1 | DP420NS | 7030 | 0.5 | 2197 +/− 821 | 49.3% |
| 30 | 1 | DP420NS | 7030 | 1.0 | 1608 +/− 618 | 36.1% |
| 31 | 1 | DP420NS | 7030 | 1.5 | 1078 +/− 243 | 24.2% |
| 32 | 1 | DP420NS | 4060 | 0.5 | 1445 +/− 571 | 32.4% |
| 33 | 1 | DP420NS | 4060 | 1.0 | 1998 +/− 529 | 44.8% |
| 34 | 1 | DP420NS | 4060 | 1.5 | 1583 +/− 685 | 35.5% |
| 35 | 2 | DP420NS | 9010 | 1.0 | 911 +/− 156 | 78.5% |
| 36 | 2 | DP420NS | 9010 | 1.5 | 604 +/− 44 | 52.0% |
| 37 | 2 | DP420NS | 7030 | 1.0 | 670 +/− 101 | 57.8% |
| 38 | 2 | DP420NS | 7030 | 1.5 | 528 +/− 57 | 45.5% |
| 39 | 2 | DP420NS | 4060 | 1.0 | 958 +/− 90 | 82.5% |
| 40 | 2 | DP420NS | 4060 | 1.5 | 676 +/− 102 | 58.2% |
| 41 | 2 | DP8610NS | 9010 | 0.5 | 1398 +/− 31 | 72.7% |
| 42 | 2 | DP8610NS | 9010 | 1.0 | 1084 +/− 46 | 56.3% |
| 43 | 2 | DP8610NS | 9010 | 1.5 | 870 +/− 31 | 45.2% |
| 44 | 2 | DP8610NS | 7030 | 0.5 | 1445 +/− 23 | 75.1% |
| 45 | 2 | DP8610NS | 7030 | 1.0 | 1067 +/− 56 | 55.3% |
| 46 | 2 | DP8610NS | 7030 | 1.5 | 869 +/− 23 | 45.2% |
| 47 | 2 | DP8610NS | 4060 | 0.5 | 1376 +/− 56 | 75.1% |
| 48 | 2 | DP8610NS | 4060 | 1.0 | 1065 +/− 184 | 55.3% |
| 49 | 2 | DP8610NS | 4060 | 1.5 | 949 +/− 88 | 49.4% |

TABLE 5
Overlap shear strength for Control Examples C50-C52
(NO multilayer film embedded in the adhesive layer)

| | | Overlap Shear |
|---|---|---|
| Example | Adhesive Material | Strength (MPa) |
| C50 | DP420NS | 23.60 +/− 5.01 |
| C51 | DP8710NS | 10.31 +/− 2.29 |
| C52 | DP8610NS | 2.85 +/− 0.30 |

TABLE 6
Overlap shear strength for Examples 53-62 having the reported
fully embedded multilayer film and reported adhesive

| | | Embedded | | Relative Overlap |
|---|---|---|---|---|
| | Adhesive | Multilayer | Overlap Shear | Shear Strength |
| Example | Material | Film | Strength (MPa) | (% of control) |
| 53 | DP420NS | 9010 | 1.65 +/− 0.27 | 7.0% |
| 54 | DP420NS | 7030 | 3.12 +/− 0.75 | 13.2% |
| 55 | DP420NS | 4060 | 3.19 +/− 0.39 | 13.5% |
| 56 | DP8710NS | 9010 | 2.16 +/− 0.89 | 20.9% |
| 57 | DP8710NS | 7030 | 3.32 +/− 0.20 | 32.2% |
| 58 | DP8710NS | 4060 | 3.16 +/− 0.34 | 30.6% |
| 59 | DP8710NS | MOF | 10.4 +/− 2.1 | 101% |
| 60 | DP8610NS | 9010 | 1.87 +/− 0.50 | 65.4% |
| 61 | DP8610NS | 7030 | 1.74 +/− 0.29 | 60.9% |
| 62 | DP8610NS | 4060 | 2.59 +/− 0.25 | 90.9% |

### Example 63—Adhesive Tape Incorporating Multilayer Backing

METHOD A—Coatable compositions comprising acrylic polymer and monomer(s) were prepared by charging a one quart jar with 350 g of acrylic monomer in the following ratio: 30% 2EHA, 45% THFA, and 25% IBOA, along with 0.14 g of OM651, and stirred until the photoinitiator had dissolved and a homogeneous mixture was obtained. The mixture was degassed by introducing nitrogen gas into it through a tube inserted through an opening in the jar's cap and bubbling vigorously for at least 5 min. While stirring, the mixture was exposed to UV-A light thereby partially polymerizing the monomers. The light source was an array of LEDs having a peak emission wavelength of 365 nm. Following UV exposure, air was introduced into the jar.

METHOD B—“Epoxy-polyol premix” was prepared by charging a glass jar with epoxy resins in the amounts of 52.9 parts EPON828 and 26.4 parts EPON1001 and heating the slurry in a 135° C. oven until a homogenous mixture was obtained. 20.7 parts of Acclaim 2200 was added with stirring and the mixture was allowed to cool to ambient temperature. Immediately prior to use, the mixture was re-heated to ca. 200° F. (93° C.) to decrease viscosity for ease of pouring.

In a glass jar, the acrylic mixture from METHOD A (38 parts), GPTMS (1 part), HDDA (0.24 parts), UVI6976 (3 parts), epoxy-polyol premix (58 parts), and OM819 photoinitiator (0.2 parts) were combined. The jar was closed tightly with a foil-lined cap and placed on a jar-roller overnight protected from light.

### Tape-Making

Uncured tapes were obtained by carrying out the below procedure on the adhesive coating formulations from the above step. Prior to coating, the multilayer 4060 film was prepared by removing the protective liner from one side and the exposed surface (PET and PETG) was plasma treated for 2 min at a power setting of 100 and air chamber pressure of a 0.1 mbar in a plasma cleaning system (Model Atto, Diener electronic GmbH, Ebhausen, Germany). Following this, a layer of the adhesive coating solution was coated between a silicone release-coated PET liner and the plasma treated surface of the 4060 film using a two-roll coater having a gap setting to produce an adhesive coating caliper of 0.068 mm. The coated layer was exposed to a total UV-A energy of approximately 3400 mJ/cm² (from two sides with approximately 1700 mJ/cm² per side) using a plurality of LED lamps with a peak emission wavelength of 405 nm. The total UV exposure was determined using a POWER PUCK II radiometer equipped with low power sensing head (EIT, Inc., Sterling, VA).

### Comparative Example C64-Adhesive Tape Incorporating Monolithic (i.e. Non-Multilayer) Backing

Comparative Example C64 is made following the same method described for Example 63, except the 4060 film is replaced with polyethylene terephthalate film extruded to a thickness of 50 microns. The primed side of the PET is the side that is coated on and the coating caliper is 0.04 mm.

### Example 65-Multilayer Tape Wrapped Battery Separation

A standard 9 V battery was used as an exemplary battery to compare separation forces. The battery surface was prepared by first using ethyl acetate to clean the surface of organic residues followed by scrubbing the surface with a SCOTCH-BRITE GENERAL PURPOSE HAND PAD #7447 (3M) attached to a handheld power sander (RYOBI 2 Amp Corded ¼ Sheet Sander, Hiroshima, Japan). The battery surface was then cleaned with methyl ethyl ketone. The adhesive tape described in Example 63 was cut into strips approximately 2.5 in wide, and approximately 3.5 in long. The other protective film was removed and the exposed surface was cleaned with IPA, and then plasma treated for 2 min at a power setting of 100 and air chamber pressure of a 0.1 mbar in a plasma cleaning system (Model Atto, Diener electronic GmbH, Ebhausen, Germany). The multilayer tape was then exposed to UV-A radiation using an array of LEDs having a peak emission wavelength of 365 nm (OmniCure AC8150, Excelitas Technologies, Waltham, MA). The total UV-A energy was determined using a POWER PUCK II radiometer (EIT, Inc., Sterling, VA) achieving 4 J/cm². The silicone release liner was then removed, and the tape was wrapped around the prepared 9V battery, cutting off any excess. A small tape overlap joint was left on the narrow face of the battery. Test samples according to FIG. 5 were fabricated using first and second rigid aluminum substrates (e.g. adherends) machined from 6061 alloy of aluminum, illustrated in FIG. 3. The bond surface of all substrates (e.g. adherends) were grit blasted with abrasive (details available) and then wiped with methyl ethyl ketone solvent. A small amount of DP8710NS adhesive was dispensed onto the end portion of the two metal angles, enough to cover the surface of the broad side of a 9V battery, and spacer beads measuring 0.85 mm in diameter and below by sieving a wider size distribution of commercially available glass beads (obtained under the trade designation P-047 with U.S. screen size of 16-25 from Potters Industries Inc., Carlstadt, New Jersey) were sprinkled on top. The broad side of the battery was then placed on the adhesive of one of the substrates (e.g. adherends) and then the second substrate (e.g., adherend) was placed on top of the opposite broad side of the battery. The stack was bonded together such that the back edge of the battery lined up with the end of each aluminum substrates (e.g. adherend as shown in FIG. 9. The bond was secured with a c-clamp and the sample was left at ambient conditions for greater than 24 h prior to testing. Finally, a separation cleavage strength of the sample was determined by mounting it on a load frame (Model Criterion C43, MTS Systems Corporation, Eden Prairie, Minnesota with a 10 kN load cell) using 30 kN wedge-action tension grips with textured wedge faces (MTS Systems Corporation) to engage the short arms (those including holes), loading the sample in tension at a rate of 1.3 in per min. The maximum load was recorded as the separation cleavage strength. The average separation strength of two samples was 36 N +/−10 with no perceived damage to the 9V battery. The samples were inspected to confirm that cleavage occurred between layers of the multilayer film.

### Comparative Example C66-Non-Multilayer Tape Wrapped Battery Separation

Comparative Example C66 test samples are fabricated in the same way as described in Example 65, except that the non-multilayer tape described in Comparative Example C64 is used instead of the Example 66 multilayer tape. The average separation strength of two samples was 251 N +/−114 with damage to the 9 V battery in the form of the metal casing pulled away from the core.

All the samples were inspected after cleavage testing and overlap shear testing to determine where the bond separation occurred. The bond separation from cleavage testing and overlap shear testing occurred at an internal interface (i.e., between layers) of the multilayer film for all the samples.

### Overlap Shear Strength Test Method 2

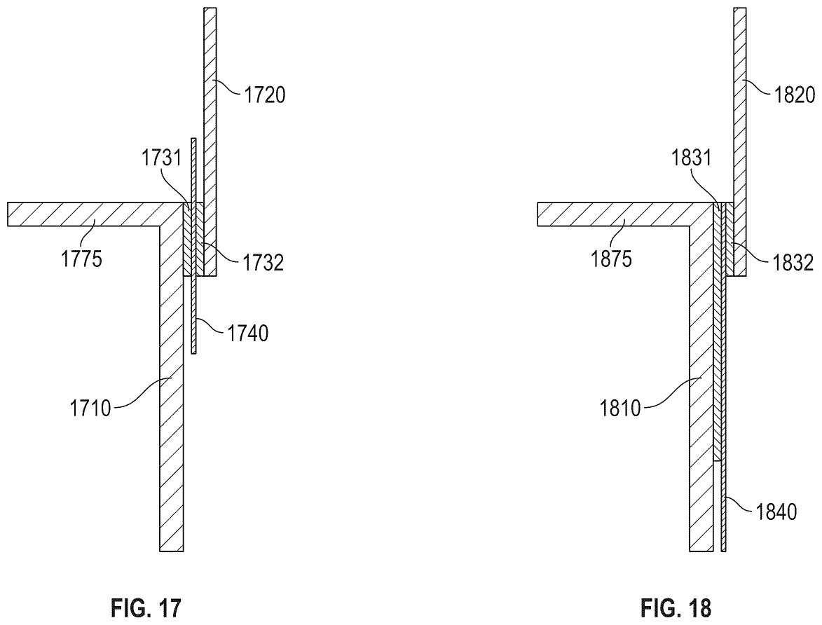

Test samples according to FIG. 17 were fabricated using a rigid aluminum (first) substrate 1710 machined from 6061 alloy of aluminum, illustrated in FIG. 7 and a 1.6 mm thick flat rectangular (second) substrate 1720 of 6061 alloy of aluminum measuring 4 inches by 1 inch. substrate.

Samples included a film (e.g., a co-extruded multilayer film) 1740 approximately centered between a first layer of structural adhesive 1731 directly adjacent to the first substrate and a second layer of structural adhesive 1732 directly adjacent to the second substrate. The intended bond surface of all substrates were grit blasted with aluminum oxide 220 grit abrasive and then cleaned by immersing briefly in heptane, followed by spraying and wiping with a mixture (50/50 by volume) of isopropyl alcohol and deionized water, followed by drying.

Uncured adhesive was first dispensed (using a static mixing nozzle) onto the first substrate with a thickness of greater than 0.5 mm. The bond line thickness was set by sprinkling into the adhesive layer some commercially available glass beads with an average size of 0.365 mm (obtained under the trade designation P-0170 with U.S. screen size of 40-50 from Potters Industries Inc., Carlstadt, New Jersey) before placing the plasma treated co-extruded multilayer film (cut to 1.625 in×1.5 in) upon the adhesive. The 1 inch×3 inch, 1.6 mm thick rectangular aluminum piece or 1 inch×3 inch glass microscope slide was then placed on top of the multilayer film and secured in place with a binder clip to ensure a uniform and flat bond between the substrate and multilayer film. This assembly was then put into the oven at 60 deg C. for 10 minutes for the adhesive to reach the gel point at which point the binder clip and rectangular aluminum piece or glass microscope slide was removed, exposing the multilayer film, prior to placing the second substrate. Uncured adhesive was then dispensed (using a static mixing nozzle) onto the second substrate with a thickness of greater than 0.5 mm. The bond line thickness was set by sprinkling into the adhesive layer some commercially available glass beads with an average size of 0.365 mm (obtained under the trade designation P-0170 with U.S. screen size of 40-50 from Potters Industries Inc., Carlstadt, New Jersey). The 1 inch×3 inch, 1.6 mm thick rectangular aluminum piece or 1 inch×3 inch glass microscope slide was then placed onto the exposed multilayer film (bonded to the first substrate) using a PTFE jig machined with pockets for receiving both substrates and securing them into place. The jig was used to bond the samples such that there was a consistent one half inch by one inch overlap, followed by clamping the substrate with binder clips. The curing assembly was placed into an oven at 60° C. for 1 hr to begin curing the adhesive. Excess cured adhesive was trimmed using a blade, followed by further curing at room temperature for at least one day.

The overlap shear separation force of the samples was determined by mounting each on a load frame (Model Criterion C43, MTS Systems Corporation, Eden Prairie, Minnesota with a 10 kN load cell) using 30 kN wedge-action tension grips with textured wedge faces (MTS Systems Corporation) applied to substrate 1720 and the section of substrate 1710 parallel to substrate 1720. Samples were loaded in tension at a rate of 2.5 mm/min (imposing shear stress on the adhesive bond). The maximum load was recorded. After separation, the dimensions of the bond which had been revealed were measured using a ruler and the bond area was calculated. The maximum load was divided by the calculated bond area to yield the overlap shear strength of the bond. The average strength of three samples +/−one standard deviation is reported.

### Overlap Shear Strength Test Method 3

Test samples according to FIG. 18 were fabricated using a rigid aluminum (first) substrate 1810 machined from 6061 alloy of aluminum substrate, illustrated in FIG. 7 and a 1.6 mm thick flat rectangular (second) substrate 1820 of 6061 alloy of aluminum measuring 4 inches by 1 inch. substrate.

Samples included a film (e.g., a co-extruded multilayer film) 1840 approximately centered between a first layer of structural adhesive 1831 directly adjacent to the first substrate and a second layer of structural adhesive 1832 directly adjacent to the second substrate. The intended bond surface of all substrates were grit blasted with aluminum oxide 220 grit abrasive and then cleaned by immersing briefly in heptane, followed by spraying and wiping with a mixture (50/50 by volume) of isopropyl alcohol and deionized water, followed by drying.

The first substrate for Overlap Shear Strength Test Method 3 was the first substrate with delaminated multilayer film portion resulting from Cleavage Strength Test Method 3. The exposed surface of the portion of multilayer film was plasma treated as described in Preparation of Multilayer Films.

Uncured adhesive was dispensed (using a static mixing nozzle) onto the second substrate with a thickness of greater than 0.5 mm. The bond line thickness was set by sprinkling into the adhesive layer some commercially available glass beads with an average size of 0.365 mm (obtained under the trade designation P-0170 with U.S. screen size of 40-50 from Potters Industries Inc., Carlstadt, New Jersey). The second substrate was then placed onto the exposed multilayer film (bonded to the first substrate) using a PTFE jig machined with pockets for receiving both substrates and securing them into place. The jig was used to bond the samples such that there was a consistent one half inch by one inch overlap, followed by clamping the substrates with binder clips. The curing assembly was placed into an oven at 60° C. for 1 hr to begin curing the adhesive. Excess cured adhesive was trimmed using a blade followed by further curing at room temperature for at least one day.

The overlap shear separation force of the samples was determined as described in Overlap Shear Strength Test Method 2.

### Overlap Shear Strength Test Method 4

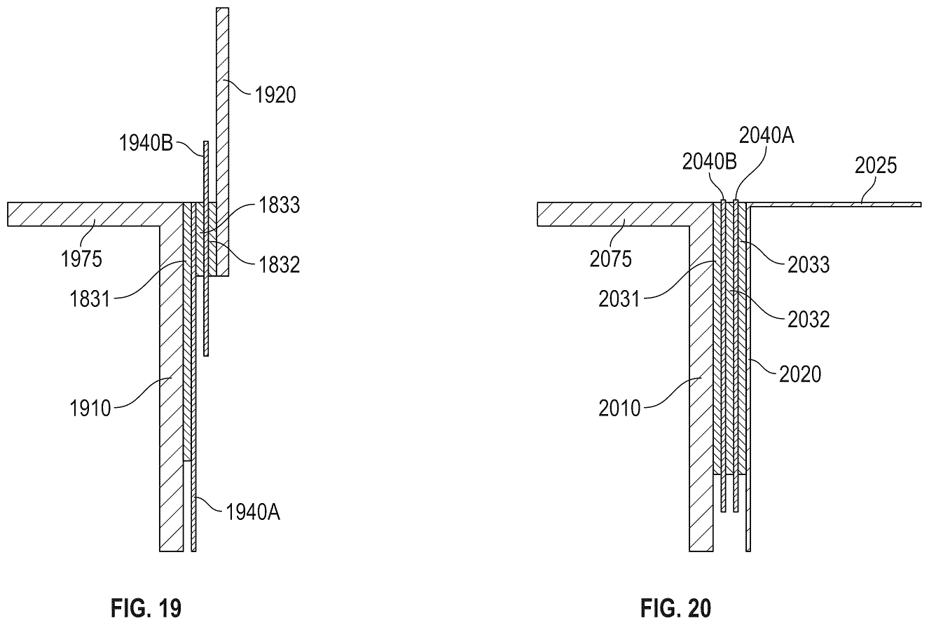

Test samples according to FIG. 19 were fabricated using a rigid aluminum (first) substrate 1910 machined from 6061 alloy of aluminum, illustrated in FIG. 7 and a 1.6 mm thick flat rectangular second substrate 1920 of 6061 alloy of aluminum measuring 4 inches by 1 inch.

Samples included (e.g., delaminated) film 1940A and (e.g. multilayer) films 1940B. Approximately ⅓ of the total adhesive layer thickness was between each substrate and adjacent film and ⅓ was between the films (1831, 1832, 1833). The intended bond surfaces of all substrates were grit blasted with aluminum oxide 220 grit abrasive and then cleaned by immersing briefly in heptane, followed by spraying and wiping with a mixture (50/50 by volume) of isopropyl alcohol and deionized water, followed by drying.

The first substrate for Overlap Shear Strength Test Method 4 was the first substrate with delaminated multilayer film resulting from Cleavage Strength Test Method 3. The exposed surface of the portion of delaminated multilayer film was plasma treated as described in Preparation of Multilayer Films. Uncured adhesive was first dispensed (using a static mixing nozzle) onto the delaminated multilayer film of the first substrate with a thickness of greater than 0.5 mm. Uncured adhesive was then dispensed (using a static mixing nozzle) onto the second substrate with a thickness of greater than 0.5 mm. The bond line thickness was set by sprinkling into the adhesive layer some commercially available glass beads with an average size of 0.365 mm (obtained under the trade designation P-0170 with U.S. screen size of 40-50 from Potters Industries Inc., Carlstadt, New Jersey). The second substrate was then placed onto the exposed multilayer film using a PTFE jig machined with pockets for receiving both substrates and securing them into place. The jig was used to bond the samples such that there was a consistent one half inch by one inch overlap, followed by clamping the substrate with binder clips. The curing assembly was placed into an oven at 60° C. for 1 hr to begin curing the adhesive, excess cured adhesive was trimmed using a blade, followed by further curing at room temperature for at least one day.

The overlap shear separation force of the samples was determined as described in Overlap Shear Strength Test Method 2.

### Cleavage Strength Test Method 4

Test samples according to FIG. 3 were fabricated using a rigid aluminum first substrate machined from 6061 alloy of aluminum, illustrated in FIG. 7 and a less rigid, more deformable L-shaped second substrate than the rigid substrate shown in FIG. 7. The second substrate had a 4 in leg, a 2 in leg, and width of 1 in, the same leg and width dimensions as the rigid first substrate shown in FIG. 7. The second substrate had a thickness of 0.9 mm (vs. the 0.25 in thickness shown in FIG. 7 for the rigid first substrate) and was formed by bending a 1 inch by 6 inch sized 0.9 mm thick sheet of 5052 alloy of aluminum. The second substrate deformed during the application of load to the article.

The first substrate for Cleavage Strength Test Method 4 was the first substrate with delaminated multilayer film resulting from substrate Cleavage Strength Test Method 3. The exposed surface of the portion of multilayer film was plasma treated as described in Preparation of Multilayer Films.

Samples included a film (e.g., a co-extruded multilayer film) approximately centered between a first layer of structural adhesive directly adjacent to the first substrate and a second layer of structural adhesive directly adjacent to the second substrate. The intended bond surface of all substrates were grit blasted with aluminum oxide 220 grit abrasive and then cleaned by immersing briefly in heptane, followed by spraying and wiping with a mixture (50/50 by volume) of isopropyl alcohol and deionized water, followed by drying.

The Cleavage Strength Test Method 4 cleavage strength was determined using a load frame and is reported in the same manner as described for Cleavage Test Method 1, for 3 samples.

### Cleavage Strength Test Method 5

Test samples according to FIG. 20 were fabricated using a rigid aluminum first substrate 2010 machined from 6061 alloy of aluminum, illustrated in FIG. 7 and a less rigid, more deformable L-shaped second substrate 2020 than the rigid substrate shown in FIG. 7. The less rigid second substrate had a 4 in leg, a 2 in leg, and width of 1 in, the same leg and width dimensions as the rigid substrate shown in FIG. 7. The less rigid second substrate had a thickness of 0.9 mm (vs. the 0.25 in thickness shown in FIG. 7 for the rigid first substrate) and was formed by bending a 1 inch by 6 inch sized 0.9 mm thick sheet of 5052 alloy of aluminum. The replacement substrate deformed during the application of load to the article.

Samples included delaminated (e.g. multilayer) film 2040B and (e.g., multilayer) film 2040A, that divided the adhesive layer thickness in thirds as previously described. The intended bond surface of all substrates were grit blasted with aluminum oxide 220 grit abrasive and then cleaned by immersing briefly in heptane, followed by spraying and wiping with a mixture (50/50 by volume) of isopropyl alcohol and deionized water, followed by drying.

The samples were formed using the methods described under Cleavage Strength Test Method 1, except that the first substrate was the first substrate with the delaminated multilayer film portion resulting from Cleavage Strength Test Method 3. The exposed surface of the portion of multilayer film was plasma treated as described in Preparation of Multilayer Films. The substrate that had been used first to carry out Cleavage Strength Test Method 3, with its layer of adhesive and portion of multilayer film present, was loaded into the machined PTFE block and the remainder of the Cleavage Strength Test Method 1 procedure was carried out. This procedure led to samples with a first film nearest to the first substrate and comprising a portion of the multilayer film present before it was used for Cleavage Test Method 3 and a second film (i.e., a multilayer film) nearest to the second (deformable) substrate. Each of the three adhesive layers of the samples was approximately 1.5 mm in thickness.

### Example C67

Three samples were fabricated and tested according to Cleavage Strength Test Method 3, using adhesive material DP8710NS and no film present. The average and standard deviation of strength measurements is given in TABLE A.

### Example C68

Three samples were fabricated and tested according to Overlap Shear Test Method, using adhesive material DP8710NS and no film present. The average and standard deviation of strength measurements is given in TABLE B.

### Example 69

Six samples were fabricated and tested according to Cleavage Strength Test Method 3, using adhesive material DP8710NS and coextruded multilayer film MOF. The average and standard deviation of strength measurements is given in TABLE A. As compared with Example C67 (no multilayer film present), the force required to separate the substrates was reduced from 1691 N/inch to 372 N/inch (reduction to 22% of the value with no film present for easier disassembly).

### Example 70

Three samples were fabricated and tested according to Cleavage Strength Test Method 4, using adhesive material DP8710NS and coextruded multilayer film MOF. Each of the three first substrates for fabricating the three samples was prepared from the separated rigid substrates of Example 1 (after strength testing). The rigid substrates of Example 69 (after strength testing) included an adhesive layer and portion of multilayer film. The average and standard deviation of strength measurements is given in TABLE A. These strength measurements are for samples where the first substrates had been bonded a first time, delaminated by cleavage, and then bonded a second time (as in, for example, a first rework or repair scenario). As compared with Example C67 (no multilayer film present), the force required to separate the substrates was reduced from 1691 N/inch to 617 N/inch (reduction to 36% of the value with no film present for easier disassembly of the reworked or repaired adhesive bond).

### Example 71

Two samples were fabricated and tested according to Cleavage Strength Test Method 4, using adhesive material DP8710NS and coextruded multilayer film MOF. Each of the two first substrates for fabricating the two samples was prepared from the separated rigid substrates of Example 70 (after strength testing). The rigid substrates of Example 70 (after strength testing) included an adhesive layer and portion of multilayer film. The average and standard deviation of strength measurements is given in TABLE A. These strength measurements are for samples where the first substrate had been bonded a first time, delaminated by cleavage, bonded a second time (as in, for example, a first rework or repair scenario) and delaminated by cleavage, and finally bonded a third time (as in, for example, a second rework or repair scenario) and delaminated by cleavage. As compared with Example C67 (no multilayer film present), the force required to separate the substrates was reduced from 1691 N/inch to 655 N/inch (reduction to 39% of the value with no film present for easier disassembly of the reworked or repaired adhesive bond).

### Example 72

One sample was fabricated and tested according to Cleavage Strength Test Method 4, using adhesive material DP8710NS and coextruded multilayer film MOF. The first substrate for fabricating the sample was prepared from the separated rigid substrates of Example 71 (after strength testing). The rigid substrate of Example 71 (after strength testing) included an adhesive layer and portion of multilayer film. The strength measurement is given in TABLE A. This strength measurement is for a sample where the first substrate had been bonded a first time, delaminated by cleavage, bonded a second time (as in, for example, a first rework or repair scenario) and delaminated by cleavage, bonded a third time (as in, for example, a second rework or repair scenario) and delaminated by cleavage, and finally bonded a fourth time (as in, for example, a third rework or repair scenario) and delaminated by cleavage. As compared with Example C67 (no multilayer film present), the cleavage force required to delaminated the substrates was reduced from 1691 N/inch to 776 N/inch (reduction to 45.9% of the value with no film present for easier disassembly of the reworked or repaired adhesive bond).

### Example 73

Three samples were fabricated and tested according to Overlap Shear Strength Test Method 2, using adhesive material DP8710 and coextruded multilayer film MOF. The average and standard deviation of strength measurements is given in TABLE B. The overlap shear strength was 8.7 MPa, as compared with 10.3 MPa for Example C68 (no multilayer film present). That is, 84% of the overlap shear strength of the adhesive was retained when the multilayer film was present, which represents retention of high overlap shear performance.

### Example 74

Three samples were fabricated and tested according to Overlap Shear Strength Test Method 3, using adhesive material DP8710NS and coextruded multilayer film MOF. Each of the three first substrates for fabricating the three samples was prepared from the separated rigid substrates of Example 69 (after strength testing). The rigid substrates of Example 69 (after strength testing) included an adhesive layer and portion of multilayer film. The average and standard deviation of strength measurements is given in TABLE B. These strength measurements are for samples where the first substrate had been bonded a first time, delaminated by cleavage, and then bonded a second time (as in, for example, a first rework or repair scenario) for the overlap shear strength measurement. The overlap shear strength was 10.1 MPa, as compared with 10.3 MPa for Example C68 (no multilayer film present). That is, 98% of the overlap shear strength of the adhesive was retained when the multilayer film was present, which represents retention of high overlap shear performance for the reworked or repaired adhesive bond.

### Example 75

A sample was fabricated and tested according to Overlap Shear Strength Test Method 3, using adhesive material DP8710NS and coextruded multilayer film MOF. The first substrate for fabricating the sample was prepared from the separated rigid substrates of Example 70 (after strength testing). The rigid substrate of Example 70 (after strength testing) included an adhesive layer and portion of multilayer film. The strength measurement result is given in TABLE B. This strength measurement is for a sample where the first substrate had been bonded a first time, delaminated by cleavage, bonded a second time (as in, for example, a first rework or repair scenario) and delaminated by cleavage, and then bonded a third time (as in, for example, a second rework or repair scenario) for the overlap shear strength measurement. The overlap shear strength was 6.0 MPa, as compared with 10.3 MPa for Example C68 (no multilayer film present). That is, 58% of the overlap shear strength of the adhesive was retained when the multilayer film was present, which represents retention of high overlap shear performance for the reworked or repaired adhesive bond.

### Example 76

A sample was fabricated and tested according to Overlap Shear Strength Test Method 3, using adhesive material DP871ONS and coextruded multilayer film MOF. The first substrate for fabricating the sample was prepared from the separated rigid substrates of Example 71 (after strength testing). The rigid substrate of Example 71 (after strength testing) included an adhesive layer and portion of multilayer film. The strength measurement result is given in TABLE B. This strength measurement is for a sample where the first substrate had been bonded a first time, delaminated by cleavage, bonded a second time (as in, for example, a first rework or repair scenario) and delaminated by cleavage, bonded a third time (as in, for example, a second rework or repair scenario) and delaminated by cleavage, and then bonded a fourth time (as in, for example, a third rework or repair scenario) for the overlap shear strength measurement. The overlap shear strength was 5.3 MPa, as compared with 10.3 MPa for Example C68 (no multilayer film present). That is, 51% of the overlap shear strength of the adhesive was retained when the multilayer film was present, which represents retention of high overlap shear performance for the reworked or repaired adhesive bond.

### Example 77

A sample was fabricated and tested according to Overlap Shear Strength Test Method 3, using adhesive material DP8710NS and coextruded multilayer film MOF. The first substrate for fabricating the sample was prepared from the separated rigid substrate of Example 72 (after strength testing). The rigid substrates of Example 72 (after strength testing) included an adhesive layer and portion of multilayer film. The strength measurement result is given in TABLE B. This strength measurement is for a sample where the first substrate had been bonded a first time, delaminated by cleavage, bonded a second time (as in, for example, a first rework or repair scenario) and delaminated by cleavage, bonded a third time (as in, for example, a second rework or repair scenario) and delaminated by cleavage, bonded a fourth time (as in, for example, a third rework or repair scenario) and delaminated by cleavage, and then bonded a fifth time (as in, for example, a fourth rework or repair scenario) for the overlap shear strength measurement. The overlap shear strength was 10.7 MPa, as compared with 10.3 MPa for Example C68 (no multilayer film present). That is, 104% of the overlap shear strength of the adhesive was retained when the multilayer film was present, which represents retention of high overlap shear performance for the reworked or repaired adhesive bond.

TABLE 7
Cleavage Strength for first, second, third, and fourth assembly
of samples with multilayer film present (Examples 69-72,
respectively), as compared to cleavage strength of analogous
assembly with no multilayer film present (Example C67).

| | | Example | | Example | | Example | | Example |
|---|---|---|---|---|---|---|---|---|
| Example | | 69 | | 70 | | 71 | | 72 |
| C67 | | First | | Second | | Third | | Fourth |
| No film | | Assembly | | Assembly | | Assembly | | Assem- |
| Avg. | Std. | Avg. | Std. | Avg. | Std. | Avg. | Std. | bly |
| (N/in.) | Dev. | (N/in.) | Dev. | (N/in.) | Dev. | (N/in.) | Dev. | (N/in.) |
| 1691 | 93 | 320 | 169 | 617 | 94 | 655 | 245 | 776 |

TABLE 8
Overlap Shear Strength for first, second, third, fourth, and fifth
assembly of samples with multilayer film present (Examples 73-77,
respectively), as compared to cleavage strength of analogous
assembly with no multilayer film present (Example C68).

| | | Example | | Example | | Example | Example | Example |
|---|---|---|---|---|---|---|---|---|
| Example | | 73 | | 74 | | 75 | 76 | 77 |
| C6 | | First | | Second | | Third | Fourth | Fifth |
| No Film | | Assembly | | Assembly | | Assem- | Assem- | Assem- |
| Avg. | Std. | Avg. | Std. | Avg. | Std. | bly | bly | bly |
| (MPa) | Dev. | (MPa) | Dev. | (MPa) | Dev. | (MPa) | (MPa) | (MPa) |
| 10.3 | 2.3 | 8.7 | 2.9 | 10.1 | 1.3 | 6.0 | 5.3 | 10.7 |

Notably the second, third, fourth, and fifth assembly are representative of reworked, repaired, repurposed, or recycled articles, as well as combination thereof. For example, the second assembly may be a rework, the third and fourth assembly a repair, and the fifth assembly a recycled article.

### Example 78

Six samples were fabricated and tested according to Cleavage Strength Test Method 3, using adhesive material DP8710NS and coextruded multilayer film 4060. The average and standard deviation of strength measurements is given in TABLE C. As compared with Example C67 (no multilayer film present), the force required to separate the substrates was reduced from 1691 N/inch to 369 N/inch (reduction to 22% of the value with no film present for easier disassembly). The thickness of the residual adhesive layer plus the thickness of the residual portion of multilayer film (also referred to herein as the delaminated film) present on the rigid adherend after testing was approximately 1.3 mm.

### Example 79

Three samples were fabricated and tested according to Cleavage Strength Test Method 4, using adhesive material DP8710NS and coextruded multilayer film 4060. Each of the three first substrates for fabricating the three samples was prepared from the separated rigid substrates of Example 78 (after strength testing). The rigid substrates of Example 78 (after strength testing) included a residual adhesive layer and delaminated portion of multilayer film. The total thickness of the residual adhesive layer and the delaminated film present on the rigid substrate after testing in Example 78, plus the additional layer of coextruded multilayer film 4060 (also referred to herein as the repair film) plus adhesive material DP8710NS interposed between the additional layer of multilayer film and the delaminated film of Example 78 (also referred to herein as the repair adhesive), was approximately 2.5 mm. That is, the total thickness of the two adhesive layers plus the two coextruded multilayer films for the re-bonded parts of Example 79 was approximately 92% greater than the total thickness (1.3 mm) of one adhesive layer and one coextruded multilayer film of the originally bonded parts of Example 78 (stated otherwise as 192% of the total thickness (1.3 mm) of one adhesive layer and one coextruded multilayer film of the originally bonded parts of Example 78). The average and standard deviation of strength measurements is given in TABLE C. These strength measurements are for samples where the first substrate had been bonded a first time, delaminated by cleavage, and then bonded a second time (as in, for example, a rework or repair scenario). As compared with Example C67 (no multilayer film present), the force required to separate the substrates was reduced from 1691 N/inch to 273 N/inch (reduction to 16% of the value with no film present for easier disassembly of the reworked or repaired adhesive bond).

### Example 80

Three samples were fabricated and tested according to Overlap Shear Strength Test Method 2, using adhesive material DP8710 and coextruded multilayer film 4060. The average and standard deviation of strength measurements is given in TABLE D. The overlap shear strength was 4.0 MPa, as compared with 10.3 MPa for Example C68 (no multilayer film present). That is, over 2 MPa of overlap shear strength was retained when the multilayer film was present, which represents retention of useful overlap shear performance.

### Example 81

Three samples were fabricated and tested according to Overlap Shear Strength Test Method 3, using adhesive material DP8710NS and coextruded multilayer film 4060. Each of the three first substrates for fabricating the three samples was prepared from the separated rigid substrates of Example 78 (after strength testing). The rigid substrates of Example 78 (after strength testing) included an adhesive layer and portion of multilayer film. The average and standard deviation of strength measurements is given in TABLE D. These strength measurements are for samples where the first substrate had been bonded a first time, delaminated by cleavage, and then bonded a second time (as in, for example, a rework or repair scenario). The overlap shear strength was 2.5 MPa, as compared with 10.3 MPa for Example C68 (no multilayer film present). That is, over 2 MPa of overlap shear strength was retained when the multilayer film was present, which represents retention of useful overlap shear performance for the reworked or repaired adhesive bond.

TABLE 9
Cleavage Strength for first assembly of samples with multilayer
film present (Example 78) and for second assembly of samples
with cleaved multilayer film and repair multilayer film present
(Example 79), as compared to cleavage strength of analogous
assembly with no multilayer film present (Example C67).

| Example C67 | | Example 78 | | Example 79 | |
|---|---|---|---|---|---|
| No Film | | First Assembly | | Second Assembly | |
| Average | Standard | Average | Standard | Average | Standard |
| (N/inch) | Deviation | (N/inch) | Deviation | (N/inch) | Deviation |
| 1691 | 93.3 | 369 | 168 | 273 | 34 |

TABLE 10
Overlap Shear Strength for first assembly of samples with multilayer
film present (Example 80) and for second assembly of samples
with delaminated multilayer film and repair multilayer film present
(Example 81), as compared to cleavage strength of analogous assembly
with no multilayer film present (Example C68).

| Example C68 | | Example 80 | | Example 81 | |
|---|---|---|---|---|---|
| No Film | | First Assembly | | Second Assembly | |
| Average | Standard | Average | Standard | Average | Standard |
| (MPa) | Deviation | (MPa) | Deviation | (MPa) | Deviation |
| 10.3 | 2.3 | 4.0 | 0.5 | 2.5 | 0.7 |

### Example 82

Example 79 can be repeated, except with the substitution of the tape of Example 63 for the repair adhesive and repair film used in Example 79. The tape of Example 63 comprises a backing of coextruded multilayer film (4060) with thickness of approximately 0.068 mm and an adhesive layer with thickness of approximately 0.068 mm. The total thickness of the tape is approximately 0.14 mm. As a result of substituting the tape of Example 63 (also referred to herein as a repair tape) for the repair adhesive and repair film used in Example 79, the total thickness of the residual adhesive layer and the delaminated film present on the rigid substrate after testing in Example 78, plus the repair tape applied to delaminated film, would be approximately 1.44 mm. That is, the total thickness of the two adhesive layers plus the two coextruded multilayer films for the re-bonded parts of Example 79 would be approximately 0.14 mm (11%) greater than the total thickness (1.3 mm) of one adhesive layer and one coextruded multilayer film of the originally bonded parts of Example 78 (stated otherwise as 111% of the total thickness (1.3 mm) of one adhesive layer and one coextruded multilayer film of the originally bonded parts of Example 78).

1. An article comprising
a first substrate;
a second substrate;
at least one adhesive layer disposed between the first and second substrates; and
a multilayer film within at least a portion of the adhesive layer(s).

2. The article of claim 1 wherein the multilayer film has an interlayer peel delamination strength at 23° C. of at least 10, 50, 100, 200, or 500 g/inch (2.54 cm).

3. The article of claim 1 wherein the article is subject to temperatures of at least 60 or 70° C. during normal use of the article.

4. The article of claim 1 wherein the first and optionally second substrate comprise metal in contact with an adhesive layer.

5. The article of claim 1 wherein the article is a battery pack.

6. The article of claim 5 wherein the first metal substrate is a battery cell and the second substrate is a cooling plate.

7. The article of claim 5 wherein the first and second substrates are electrochemical cells.

8. (canceled)

9. The article of claim 1 wherein a layer of the multilayer film has a Tg of at least 70, 80, 90, 100, 115, 120, or 125° C.

10. The article of claim 1 wherein the multilayer film has a melt temperature of at least 150, 160, 170, 180, 190, 200, 210, 220, 230, 240, 250, 260, 270, or 280° C.

11. The article of claim 1 wherein the multilayer film comprises at least two layers that differ in crystallinity.

12. (canceled)

13. The article of claim 1 wherein the multilayer film comprises at least 3, 4, 5, 6, 7, 9, 10, 50, 100, or 200 layers.

14. (canceled)

15. The article of claim 1 wherein the multilayer film fully spans or partially spans the adhesive layer.

16. The article of claim 15 wherein the multilayer film partially spans the adhesive layer and the article further comprises an insulating layer adhesively bonded between the multilayer film and the first or second substrate.

17. The article of claim 1 wherein the adhesive layer has a middle region disposed between two opposing edge regions and the multilayer film is present at one or both edge regions.

18. The article of claim 1 wherein the adhesive layer is set back with respect to the edge of the first and second substrates.

19. The article of claim 1 wherein the multilayer film is disposed between a first adhesive layer bonding the first substrate to the multilayer film and a second adhesive layer bonding the second substrate to the multilayer film.

20. (canceled)

21. The article of claim 1 comprising one or more of the following properties
a) wherein the first and optionally second adhesive layer has a Young's modulus of less than 2000 MPa, 1700 MPa, 1000 MPa, 500 MPa, 250 MPa, or less than 100 MPa;
b) the multilayer film has an interlayer peel delamination strength at 23° C. of at least 50 gf/inch and the first and optionally second adhesive layer has a Young's modulus of less than 1700 MPa;
c) the adhesive layer has an overlap shear strength is at least 2 MPa, 3 MPa, 5 MPa, 10 MPa, 15 MPa, or 20 MPa at 23° C.;
d) the article has a cleavage strength at 23° C. of less than 5000, 2000, 1500, 1000, 750, 500, or 250 N/inch; and
e) the article has a cleavage strength at 23° C. of less than 1000 N/inch and the adhesive layer has an overlap shear strength at 23° C. of at least 3 MPa.

22-25. (canceled)

26. The article of claim 1 wherein the adhesive layer(s) comprise a curable adhesive comprising (meth)acrylate moieties, urethane moieties, epoxy moieties, or combinations thereof; wherein the curable adhesive is cured.

27. The article of claim 26 wherein the curable adhesive is not a pressure sensitive adhesive after curing.

28-36. (canceled)

37. A method of disassembly comprising providing an article according to claim 1;
applying a force to separate the first substrate from the second substrate by delaminating the (e.g. multilayer) film.

38-69. (canceled)
